(19) United States
(12) Patent Application Publication
(10) Pub. No.: US 2016/0284458 A1
(43) Pub. Date: Sep. 29, 2016

(54) COIL SUBSTRATE, METHOD OF MANUFACTURING COIL SUBSTRATE AND INDUCTOR

(71) Applicant: SHINKO ELECTRIC INDUSTRIES CO., LTD., Nagano (JP)

(72) Inventors: Atsushi NAKAMURA, Nagano (JP); Tsukasa NAKANISHI, Nagano (JP); Yoichi SASADA, Nagano (JP)

(21) Appl. No.: 15/180,421

(22) Filed: Jun. 13, 2016

Related U.S. Application Data
(62) Division of application No. 14/488,400, filed on Sep. 17, 2014, now Pat. No. 9,396,874.

(30) Foreign Application Priority Data
Oct. 11, 2013 (JP) 2013-214129

(51) Int. Cl. H01F 17/00; H01F 17/04

(52) U.S. Cl. CPC H01F 17/0013; H01F 17/04; H01F 2017/048

(57) ABSTRACT

A coil substrate includes a stacked structure in which a plurality of structures are stacked, each of the structures including a first insulating layer and a wiring formed on the first insulating layer, which becomes a part of a spiral-shaped coil; and an insulating film that covers a surface of the stacked structure, the spiral-shaped coil being formed by connecting the wirings of the adjacent structures in series.

### CROSS-REFERENCE TO RELATED APPLICATION

This application is a divisional application of U.S. patent application Ser. No. 14/488,400 filed on Sep. 17, 2014, which claims the benefit of priority of Japanese Patent Application No. 2013-214129 filed on Oct. 11, 2013, where the entire contents of all of these applications are incorporated herein by reference.

### BACKGROUND OF THE INVENTION

1. Field of the Invention

The present invention relates to a coil substrate, a method of manufacturing a coil substrate and an inductor including a coil substrate.

2. Description of the Related Art

Recently, the size of an electronic device such as a game device, a smartphone or the like has been becoming smaller and smaller. In accordance with this, it is required for various elements such as an inductor or the like that is mounted on the electronic device to be smaller. As such an inductor that is mounted on the electronic device, one that uses a wire winding coil is known, for example. An inductor using a wire winding coil is used as a power supply circuit or the like of an electronic device, for example (see Patent Document 1, for example).

However, as there is a limitation in reducing the width of the wire winding, the ratio of the area occupied by the wire winding with respect to the entire area of the inductor becomes large if the size of the inductor is to be made smaller. In such a case, it is difficult to form a closed magnetic circuit. Therefore, there is a limitation in downsizing the size of the inductor using the wire winding coil while maintaining sufficient inductance and it is considered that the size of the plan shape of such an inductor is about 1.6 mm×1.6 mm at minimum.

### Patent Document

### [Patent Document 1] Japanese Laid-open Patent Publication No. 2003-168610

### SUMMARY OF THE INVENTION

The present invention is made in light of the above problems, and provides a smaller coil substrate or the like.

According to an embodiment, there is provided a coil substrate including a stacked structure in which a plurality of structures are stacked, each of the structures including a first insulating layer and a wiring formed on the first insulating layer, which becomes a part of a spiral-shaped coil; and an insulating film that covers a surface of the stacked structure, the spiral-shaped coil being formed by connecting the wirings of the adjacent structures in series.

Note that also arbitrary combinations of the above-described elements, and any changes of expressions in the present invention, made among methods, devices, systems and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1A to FIG. 1C are views illustrating an example of a coil substrate of an embodiment;

FIG. 2 is a perspective view schematically illustrating a shape of a wiring of each structure constituting the coil substrate of the embodiment;

FIG. 3 is a cross-sectional view illustrating an example of an inductor of the embodiment;

FIG. 4A and FIG. 4B are views illustrating an example of a manufacturing method of the coil substrate of the embodiment;

FIG. 5A and FIG. 5B are views illustrating an example of the manufacturing method of the coil substrate of the embodiment;

FIG. 6A and FIG. 6B are views illustrating an example of the manufacturing method of the coil substrate of the embodiment;

FIG. 7A to FIG. 7C are views illustrating an example of the manufacturing method of the coil substrate of the embodiment;

FIG. 8A to FIG. 8C are views illustrating an example of the manufacturing method of the coil substrate of the embodiment;

FIG. 9A to FIG. 9C are views illustrating an example of the manufacturing method of the coil substrate of the embodiment;

FIG. 10A and FIG. 10B are views illustrating an example of the manufacturing method of the coil substrate of the embodiment;

FIG. 11A to FIG. 11C are views illustrating an example of the manufacturing method of the coil substrate of the embodiment;

FIG. 12A to FIG. 12C are views illustrating an example of the manufacturing method of the coil substrate of the embodiment;

FIG. 13A to FIG. 13C are views illustrating an example of the manufacturing method of the coil substrate of the embodiment;

FIG. 14A to FIG. 14C are views illustrating an example of the manufacturing method of the coil substrate of the embodiment;

FIG. 15A and FIG. 15B are views illustrating an example of the manufacturing method of the coil substrate of the embodiment;

FIG. 16A to FIG. 16C are views illustrating an example of the manufacturing method of the coil substrate of the embodiment;

FIG. 17A and FIG. 17B are views illustrating an example of the manufacturing method of the coil substrate of the embodiment;

FIG. 18 is a view illustrating an example of the manufacturing method of the coil substrate of the embodiment;

FIG. 19 is a view illustrating an example of the manufacturing method of the coil substrate of the embodiment;

FIG. 20 is a view illustrating an example of the manufacturing method of the coil substrate of the embodiment;

FIG. 21A to FIG. 21C are views illustrating an example of the manufacturing method of the coil substrate of the embodiment; and

FIG. 22A to FIG. 22C are view illustrating an example of a manufacturing method of an inductor of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes. It is to be noted that, in the explanation of the drawings, the same components are given the same reference numerals, and explanations are not repeated.

### (Structure of Coil Substrate)

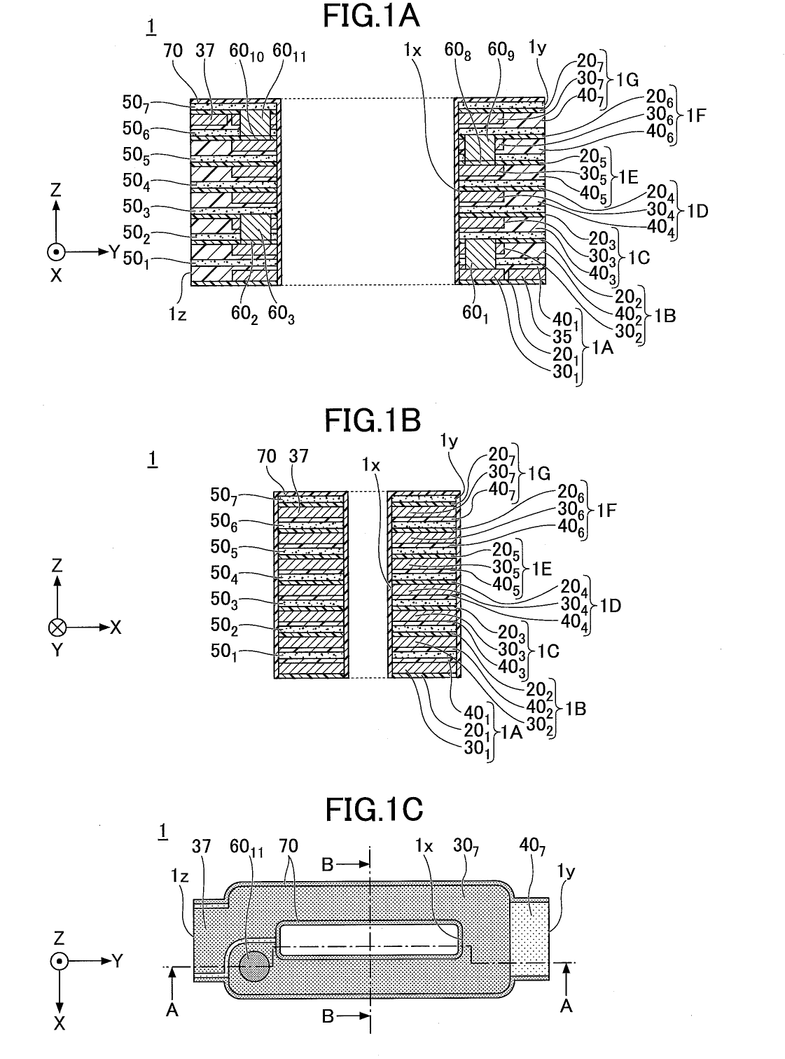

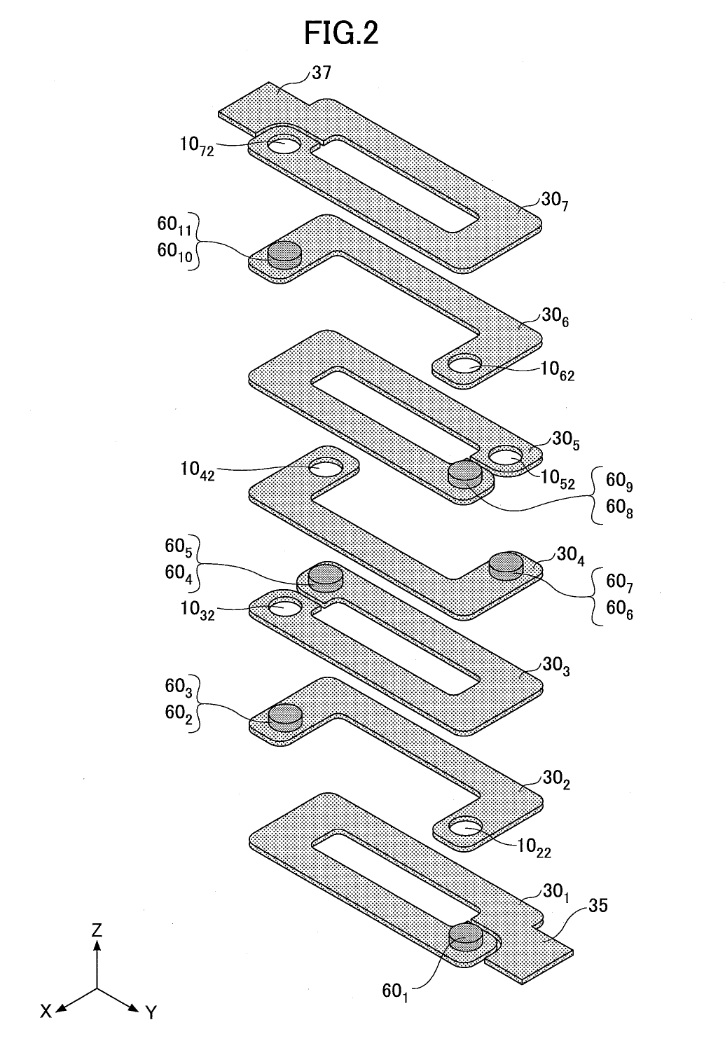

The structure of a coil substrate of the embodiment is explained. FIG. 1A to FIG. 1C are views illustrating an example of a coil substrate 1 of the embodiment. FIG. 1C is a plan view, FIG. 1A is a cross-sectional view of FIG. 1C taken along an A-A line, and FIG. 1B is a cross-sectional view of FIG. 1C taken along a B-B line. FIG. 2 is a perspective view schematically illustrating a shape of a wiring of each structure constituting the coil substrate 1 of the embodiment.

With reference to FIG. 1A to FIG. 2, the coil substrate 1 mainly includes a first structure 1A, a second structure 1B, a third structure 1C, a fourth structure 1D, a fifth structure 1E, a sixth structure 1F, a seventh structure 1G, adhesion layers 50₁ to 50₇ and an insulating film 70. In FIG. 1C, the insulating layer 20₇, the adhesion layer 50₇ and the insulating film 70 formed on the adhesion layer 50₇ are not illustrated. In FIG. 1C, a portion is illustrated in a dot pattern for explanation purposes.

Further, in the following explanation, the drawings illustrating a method of manufacturing the coil substrate 1 are appropriately referred to. Further, in FIG. 1A to FIG. 1C, numerals of open portions are not illustrated, and numerals that are illustrated in the drawings illustrating the method of manufacturing the coil substrate 1 are referred to.

In this embodiment, an adhesion layer 50₇ side is referred to as an upper side or one side, and an insulating layer 20₁ side is referred to as a lower side or the other side. Further, a surface of each component at the adhesion layer 50₇ side is referred to as an upper surface or one surface, and a surface at the insulating layer 20₁ side is referred to as a lower surface or the other surface. However, the coil substrate 1 may be used in an opposite direction or may be used at an arbitrary angle. Further, in this embodiment, “in a plan view” means that an object is seen in a direction that is normal to one surface of the insulating layer 20₁, and a “plan shape” means a shape of an object seen in the direction that is normal to the one surface of the insulating layer 20₁.

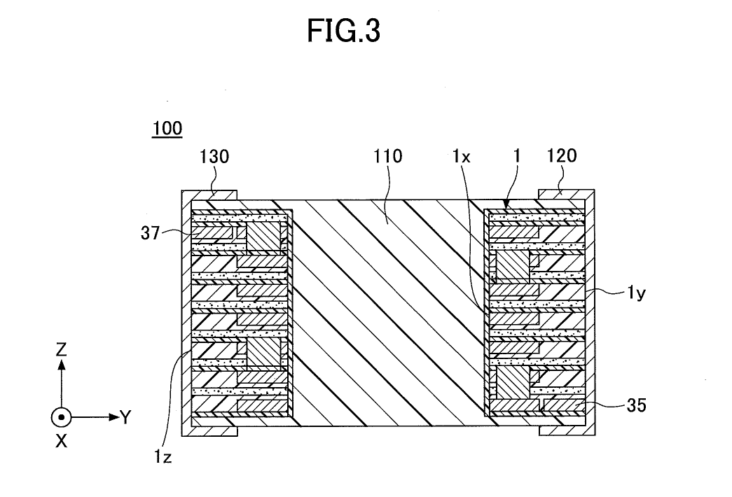

As will be explained below, the coil substrate 1 is formed into an inductor 100 (see FIG. 3). Thus, the plan shape of the coil substrate 1 may have about a size such that the plan shape of the inductor 100 has substantially a rectangular shape of about 1.6 mm×0.8 mm, for example, when manufacturing the inductor 100 using the coil substrate 1. The thickness of the coil substrate 1 may be about 0.5 mm, for example.

The plan shape (outer edge) of the coil substrate 1 is not a simple rectangular shape but is similar to the plan shape of an outer edge of each wiring (a seventh wiring 30₇ or the like) that constitute the coil substrate 1. This is in order to form a large amount of sealing resin 110 around the coil substrate 1 when manufacturing the inductor 100 (see FIG. 3) using the coil substrate 1. Further, the coil substrate 1 is provided with a through hole 1x at the substantially center portion of the coil substrate 1. Similarly, this is in order to form a larger amount of the sealing resin 110 around the coil substrate 1 when manufacturing the inductor 100 (see FIG. 3) using the coil substrate 1. By using insulating resin (epoxy based insulating resin or the like, for example) including magnetic filler such as ferrite or the like as sealing resin 110, and sealing the large amount of the part around the coil substrate 1 including the inside of the through hole 1x, for example, the inductance of the inductor 100 can be made larger.

The first structure 1A includes an insulating layer 20₁, a first wiring 30₁, a connecting portion 35 and an insulating layer 40₁. The insulating layer 20₁ is formed as an outermost layer (undermost layer in FIG. 1A) of the coil substrate 1. For the material of the insulating layer 20₁, epoxy based insulating resin or the like may be used, for example. The thickness of the insulating layer 20₁ may be about 8 to 12 μm, for example.

The first wiring 30₁ and the connecting portion 35 are formed on the insulating layer 20₁. The material of the first wiring 30₁ and the connecting portion 35 may be copper (Cu), copper alloy or the like, for example. The thickness of the first wiring 30₁ and the connecting portion 35 may be about 12 to 50 μm, for example. The width of the first wiring 30₁ may be about 50 to 130 μm, for example. The first wiring 30₁ is a first layer wiring that is a part (about a roll) of a coil, and is patterned in substantially an elliptical shape in a direction illustrated in FIG. 2. Here, a direction along the coil (Y direction) is referred to as a longer direction and a width direction that is perpendicular to the longer direction is referred so as a shorter direction (X direction). The cross-sectional shape of the first wiring 30₁ in the shorter direction is substantially a rectangular shape.

The connecting portion 35 is formed at one end portion of the first wiring 30₁. A side surface of the connecting portion 35 is exposed from one side surface 1y of the coil substrate 1 and the exposed portion is connected to an electrode of the inductor 100. The connecting portion 35 is integrally formed with the first wiring 30₁.

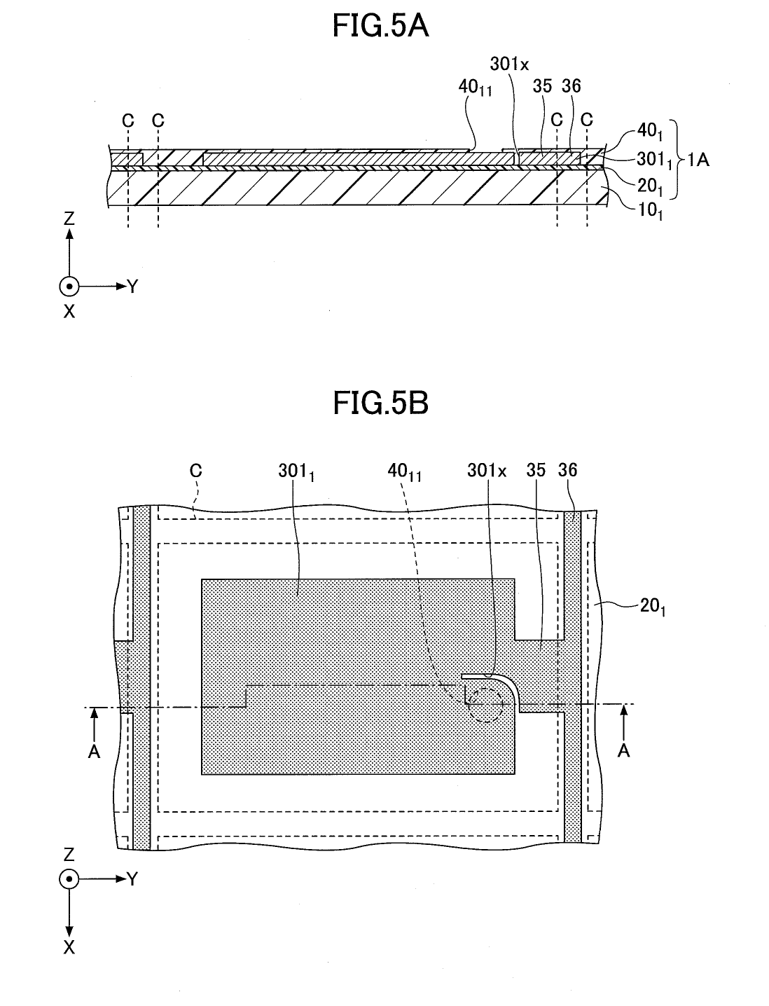

The insulating layer 40₁ is formed on the insulating layer 20₁ such as to cover the first wiring 30₁ and the connecting portion 35. In other words, the first structure 1A includes the insulating layer 20₁, the first wiring 30₁ and the connecting portion 35 that are formed on the insulating layer 20₁ and become a part of the coil, and the insulating layer 40₁ formed on the insulating layer 20₁ such as to cover the first wiring 30₁ and the connecting portion 35. Here, one portion of the connecting portion 35 at the side surface is exposed from the insulating layer 40₁. The insulating layer 40₁ is provided with an open portion (open portion 40₁₁ in FIG. 5A) that exposes an upper surface of the first wiring 30₁, and a part of a via wiring 60₁ is filled in the open portion to be electrically connected with the first wiring 30₁. For the material of the insulating layer 40₁, photosensitive epoxy based insulating resin or the like may be used, for example. The thickness of the insulating layer 40₁ may be about 5 to 30 μm (the thickness from the upper surface of the first wiring 30₁), for example.

The second structure 1B is stacked on the first structure 1A through the adhesion layer 50₁. The second structure 1B includes an insulating layer 20₂, a second wiring 30₂ and an insulating layer 40₂. As the adhesion layer 50₁, a heat resistance adhesive made of insulating resin such as epoxy based adhesive, polyimide based adhesive or the like may be used, for example. The thickness of the adhesion layer 50₁ may be about 10 to 40 μm, for example.

Here, in the following, the shape, the thickness, the material and the like of an insulating layer 20n, an insulating layer 40n and an adhesion layer 50n (here, “n” is a natural number more than or equal to 2) are the same as those of the insulating layer 20₁, insulating layer 40₁ and the adhesion layer 50₁ unless otherwise explained.

Further, the insulating layer 20n may be referred to as a first insulating layer and the insulating layer 40n may be referred to as a second insulating layer. Although the insulating layer 20n and the insulating layer 40n are added different numerals for explanation purposes, both function as insulating layers that cover the respective wiring. Thus, the insulating layer 20n and the insulating layer 40n in total may referred to as an insulating layer. Here, the coil substrate 1 may not include the insulating layer 40n when the wirings of the structures can be surely insulated from each other by the adhesion layer 50n.

The insulating layer 40₂ is stacked on the adhesion layer 50₁. A bottom surface and a side surface of the second wiring 30₂ are covered by the insulating layer 40₂ and an upper surface of the second wiring 30₂ is exposed from the insulating layer 40₂. The material, the thickness and the like of the second wiring 30₂ may be the same as those of the first wiring 30₁. The second wiring 30₂ is a second layer wiring that is a part (about ¾ roll) of the coil, and is patterned in substantially a semi-elliptical shape in the direction illustrated in FIG. 2. The cross-sectional shape of the second wiring 30₂ in the shorter direction is substantially a rectangular shape.

The insulating layer 20₂ is stacked on the second wiring 30₂ and the insulating layer 40₂. In other words, the second structure 1B has a vertically inversed structure of a structure including the insulating layer 20₂, the second wiring 30₂ that is formed on the insulating layer 20₂ and is a part of the coil, and the insulating layer 40₂ formed on the insulating layer 20₂ such as to cover the second wiring 30₂.

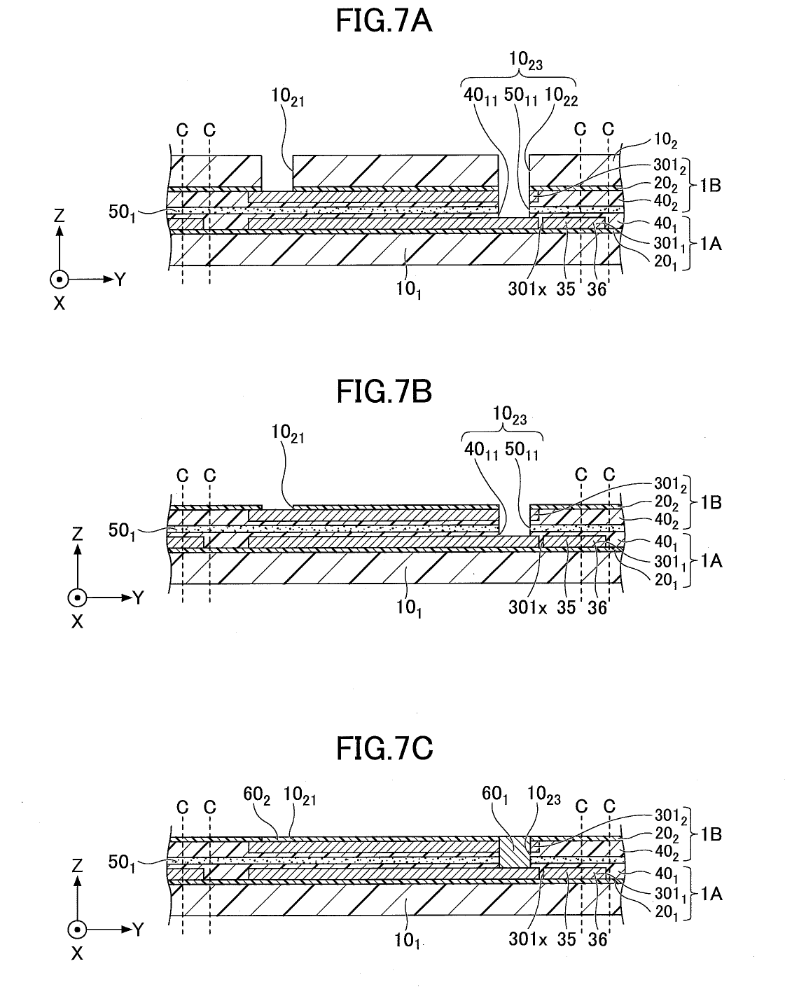

The second structure 1B is provided with an open portion that penetrates the insulating layer 20₂, the second wiring 30₂ and the insulating layer 40₂ whose lower side is in communication with an open portion of the adhesion layer 50₁ and the open portion of the insulating layer 40₁. A via wiring 60₁ is filled in these open portions (an open portion 10₂₃ illustrated in FIG. 7A). The second wiring 30₂ is electrically connected in series with the first wiring 30₁ through the via wiring 60₁. Further, the second structure 1B is provided with an open portion (an open portion 10₂₁ illustrated in FIG. 7A) that penetrates the insulating layer 20₂ and exposes an upper surface of the second wiring 30₂, and a via wiring 60₂ is filled in the open portion. The second wiring 30₂ is electrically connected to the via wiring 60₂.

The third structure 1C is stacked on the second structure 1B through the adhesion layer 50₂. The third structure 1C includes an insulating layer 20₃, a third wiring 30₃ and an insulating layer 40₃.

The insulating layer 40₃ is stacked on the adhesion layer 50₂. A bottom surface and a side surface of the third wiring 30₃ are covered by the insulating layer 40₃ and an upper surface of the third wiring 30₃ is exposed from the insulating layer 40₃. The material, the thickness and the like of the third wiring 30₃ may be the same as those of the first wiring 30₁. The third wiring 30₃ is a third layer wiring that is a part (about a roll) of the coil, and is patterned in substantially a semi-elliptical shape in the direction illustrated in FIG. 2. The cross-sectional shape of the third wiring 30₃ in the shorter direction is substantially a rectangular shape.

The insulating layer 20₃ is stacked on the third wiring 30₃ and the insulating layer 40₃. In other words, the third structure 1C has a vertically inversed structure of a structure including the insulating layer 20₃, the third wiring 30₃ that is formed on the insulating layer 20₃ and is a part of the coil, and the insulating layer 40₃ formed on the insulating layer 20₃ such as to cover the third wiring 30₃.

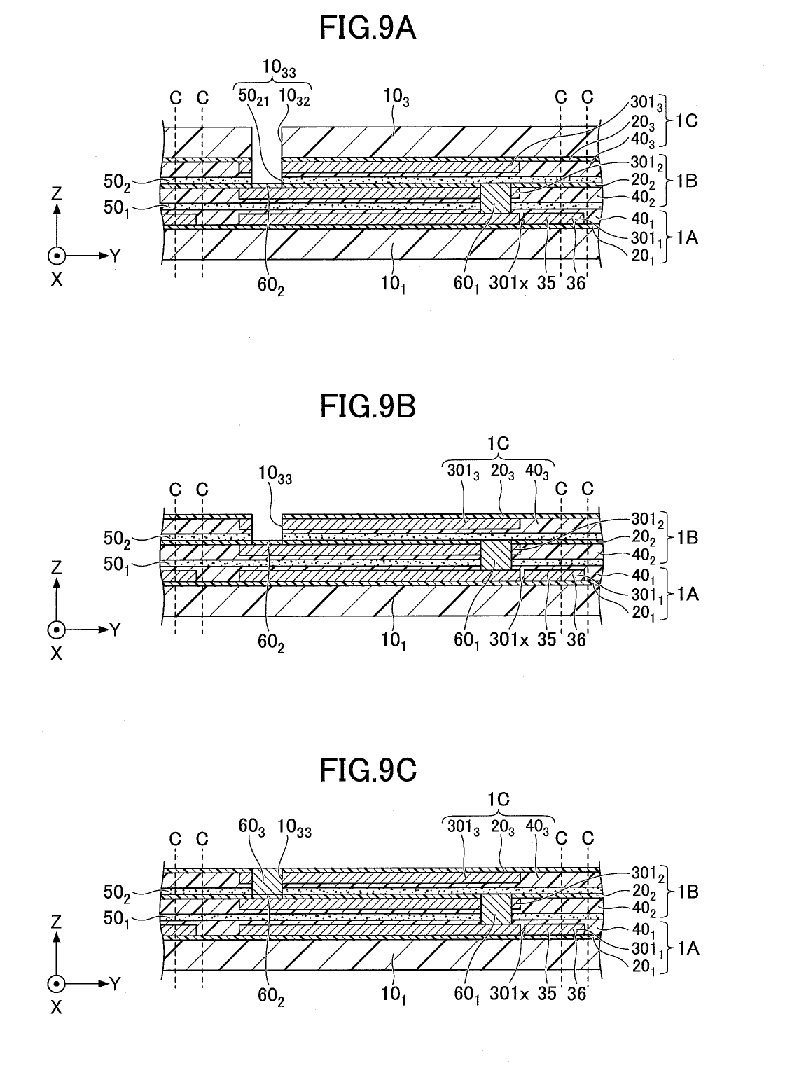

The third structure 1C is provided with an open portion that penetrates the insulating layer 20₃, the third wiring 30₃ and the insulating layer 40₃ whose lower side is in communication with an open portion of the adhesion layer 50₂. The via wiring 60₃ is filled in these open portions (an open portion 10₃₃ in FIG. 9A). The via wiring 60₃ is electrically connected to a via wiring 60₂ that is filled in the open portion of the insulating layer 20₂ of the second structure 1B. The third wiring 30₃ is electrically connected in series with the second wiring 30₂ through the via wirings 60₂ and 60₃. Further, the third structure 1C is provided with an open portion (an open portion 10₃₁ in FIG. 85) that penetrates the insulating layer 20₃ and exposes an upper surface of the third wiring 30₃. A via wiring 60₄ is filled in the open portion. The third wiring 30₃ is electrically connected to the via wiring 60₄.

The fourth structure 1D is stacked on the third structure 1C through the adhesion layer 50₃. The fourth structure 1D includes an insulating layer 20₄, a fourth wiring 30₄ and an insulating layer 40₄.

The insulating layer 40₄ is stacked on the adhesion layer 50₃. A bottom surface and a side surface of the fourth wiring 30₄ are covered by the insulating layer 40₄ and an upper surface is exposed from the insulating layer 40₄. The material, the thickness and the like of the fourth wiring 30₄ are the same as those of the first wiring 30₁. The fourth wiring 30₄ is a fourth layer wiring that is a part (about ¾ roll) of the coil, and is patterned in substantially a semi-elliptical shape in the direction illustrated in FIG. 2.

The insulating layer 20₄ is stacked on the fourth wiring 30₄ and the insulating layer 40₄. In other words, the fourth structure 1D has a vertically inversed structure of a structure including the insulating layer 20₄, the fourth wiring 30₄ that is formed on the insulating layer 20₄ and is a part of the coil, and the insulating layer 40₄ formed on the insulating layer 20₄ such as to cover the fourth wiring 30₄.

The fourth structure 1D is provided with an open portion that penetrates the insulating layer 20₄, the fourth wiring 30₄ and the insulating layer 40₄ whose lower side is in communication with an open portion of the adhesion layer 50₃. The via wiring 60₅ is filled in these open portions. The via wiring 60₅ is electrically connected to the via wiring 60₄ formed in the open portion of the insulating layer 20₃ of the third structure 1C. The fourth wiring 30₄ is electrically connected in series with the third wiring 30₃ through the via wirings 60₄ and 60₅. Further, the fourth structure 1D is provided with an open portion that penetrates the insulating layer 20₄ and exposes an upper surface of the fourth wiring 30₄. A via wiring 60₆ is filled in the open portion. The fourth wiring 30₄ is electrically connected to the via wiring 60₆.

The fourth structure 1D has the same structure as the second structure 1B and corresponds to a structure obtained by rotating the second structure 1B 180° around an axis of normal of an X-Y plane. The open portions 10₄₁ and 10₄₂ respectively correspond to the open portions 10₂₁ and 10₂₂.

The fifth structure 1E is stacked on the fourth structure 1D through the adhesion layer 50₄. The fifth structure 1E includes an insulating layer 20₅, a fifth wiring 30₅ and an insulating layer 40₅.

The insulating layer 40₅ is stacked on the adhesion layer 50₄. A bottom surface and a side surface of the fifth wiring 30₅ are covered by the insulating layer 40₅ and an upper surface of the fifth wiring 30₅ is exposed from the insulating layer 40₅. The material, the thickness and the like of the fifth wiring 30₅ may be the same as those of the first wiring 30₁. The fifth wiring 30₅ is a fifth layer wiring that is a part (about a roll) of the coil, and is patterned in substantially a semi-elliptical shape in the direction illustrated in FIG. 2. The cross-sectional shape of the fifth wiring 30₅ in the shorter direction is substantially a rectangular shape.

The insulating layer 20₅ is stacked on the fifth wiring 30₅ and the insulating layer 40₅. In other words, the fifth structure 1E has a vertically inversed structure of a structure including the insulating layer 20₅, the fifth wiring 30₅ that is formed on the insulating layer 20₅ and is a part of the coil, and the insulating layer 40₅ formed on the insulating layer 20₅ such as to cover the fifth wiring 30₅.

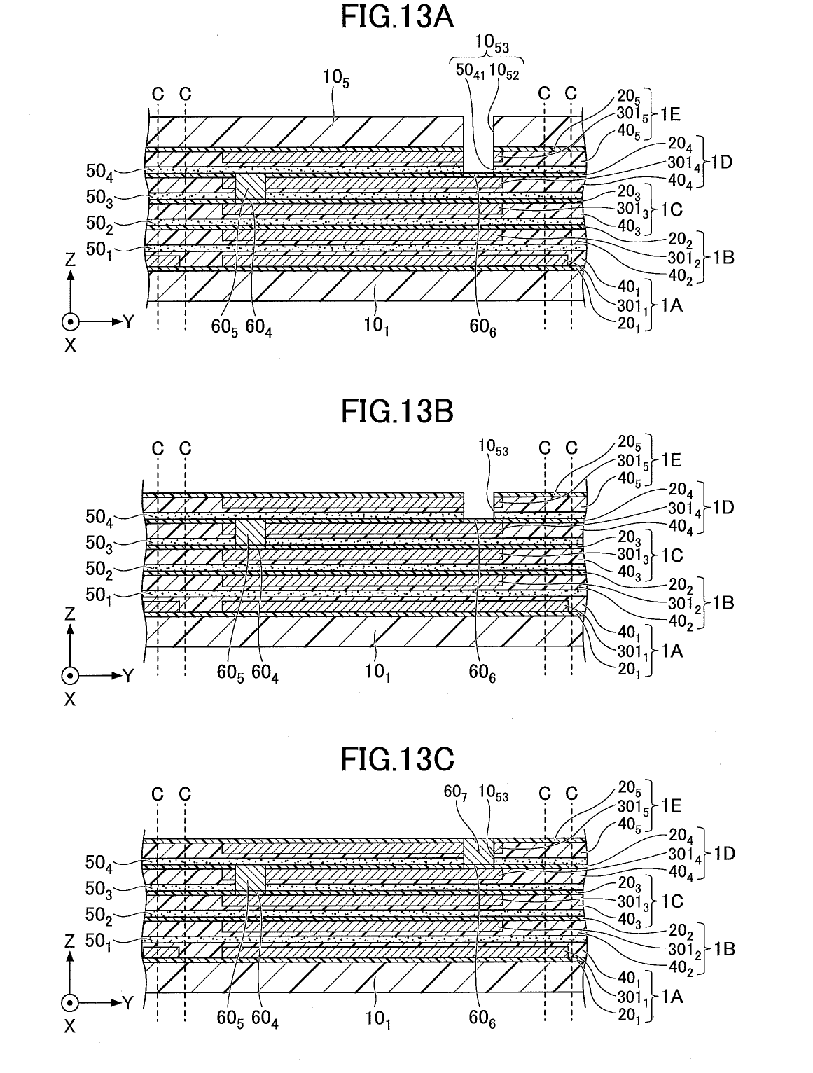

The fifth structure 1E is provided with an open portion that penetrates the insulating layer 20₅, the fifth wiring 30₅ and the insulating layer 40₅ whose lower side is in communication with an open portion of the adhesion layer 50₄. The via wiring 60₇ is filled in the open portion (an open portion 10₅₃ illustrated in FIG. 13A and FIG. 13B). The via wiring 60₇ is electrically connected to a via wiring 60₆ that is filled in the open portion of the insulating layer 20₄ of the fourth structure 1D. The fifth wiring 30₅ is electrically connected in series with the fourth wiring 30₄ through the via wirings 60₆ and 60₇. The fifth structure 1E is provided with an open portion (an open portion 10₅₁ illustrated in FIG. 123) that penetrates the insulating layer 20₅ and exposes an upper surface of the fifth wiring 30₅. A via wiring 60₈ is filled in the open portion. The fifth wiring 30₅ is electrically connected to the via wiring 60₈.

The fifth structure 1E has the same structure as the third structure 1C and corresponds to a structure obtained by rotating the third structure 1C 180° around the normal axis of the X-Y plane. The open portions 10₅₁ and 10₅₂ respectively correspond to the open portions 10₃₁ and 10₃₂.

The sixth structure 1F is stacked on the fifth structure 1E through the adhesion layer 50₅. The sixth structure 1F includes an insulating layer 20₆, a sixth wiring 30₆ and an insulating layer 40₆.

The insulating layer 40₆ is stacked on the adhesion layer 50₅. A bottom surface and a side surface of the sixth wiring 30₆ are covered by the insulating layer 40₆ and an upper surface of the sixth wiring 30₆ is exposed from the insulating layer 40₆. The material, the thickness and the like of the sixth wiring 30₆ may be the same as those of the first wiring 30₁. The sixth wiring 30₆ is a sixth layer wiring that is a part (about ¾ roll) of the coil, and is patterned in substantially a semi-elliptical shape in the direction illustrated in FIG. 2. The cross-sectional shape of the sixth wiring 30₆ in the shorter direction is substantially a rectangular shape.

The insulating layer 20₆ is stacked on the sixth wiring 30₆ and the insulating layer 40₆. In other words, the sixth structure 1F has a vertically inversed structure of a structure including the insulating layer 20₆, the sixth wiring 30₆ that is formed on the insulating layer 20₆ and is a part of the coil, and the insulating layer 40₆ formed on the insulating layer 20₆ such as to cover the sixth wiring 30₆.

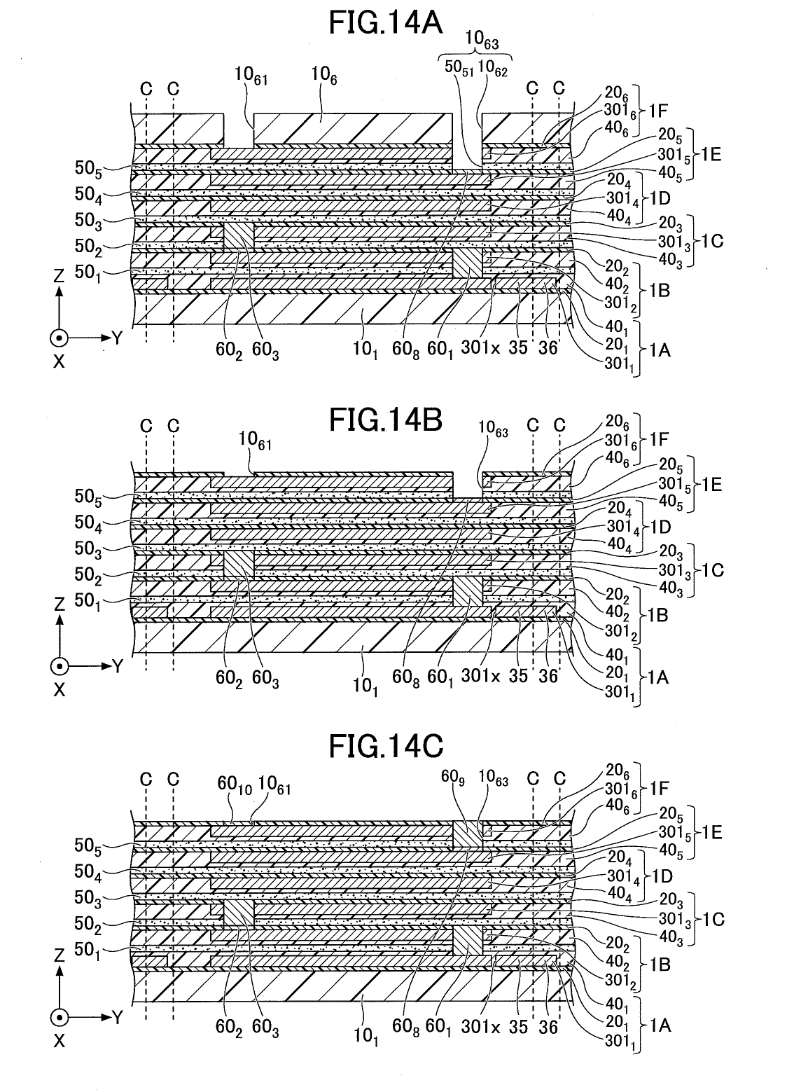

The sixth structure 1F is provided with an open portion that penetrates the insulating layer 20₆, the sixth wiring 30₆ and the insulating layer 40₆ whose lower side is in communication with an open portion of the adhesion layer 50₅. The via wiring 60₉ is filled in the open portion (an open portion 10₆₃ illustrated in FIG. 14A and FIG. 14B). The via wiring 60₉ is electrically connected to a via wiring 60₈ formed in the open portion of the insulating layer 20₅ of the fifth structure 1E. The sixth wiring 30₆ is electrically connected in series with the fifth wiring 30₅ through the via wirings 60₈ and 60₉. The sixth structure 1F is provided with an open portion (open portion 10₆₁ illustrated in FIG. 14A) that penetrates the insulating layer 20₆ and exposes an upper surface of the sixth wiring 30₆. A via wiring 60₁₀ is filled in the open portion. The sixth wiring 30₆ is electrically connected to the via wiring 60₁₀.

Although the reference numerals are different in the sixth structure 1F and the second structure 1B, the sixth structure 1F has the same structure as the second structure 1B and the open portions 10₆₁ and 10₆₂ respectively correspond to the open portions 10₂₁ and 10₂₂.

The seventh structure 1G is stacked on the sixth structure 1F through the adhesion layer 50₆. The seventh structure 1G includes an insulating layer 20₇, a seventh wiring 30₇, a connecting portion 37 and an insulating layer 40₇.

The insulating layer 40₇ is stacked on the adhesion layer 50₆. A bottom surface and a side surface of each of the seventh wiring 30₇ and the connecting portion 37 are covered by the insulating layer 40₇ and an upper surface of each of the seventh wiring 30₇ and the connecting portion 37 is exposed from the insulating layer 40₇. The material, the thickness and the like of the seventh wiring 30₇ and the connecting portion 37 are the same as those of the first wiring 30₁. The seventh wiring 30₇ is an uppermost wiring layer, and is patterned in substantially a semi-elliptical shape in the direction illustrated in FIG. 2.

The connecting portion 37 is formed at one end portion of the seventh wiring 30₇. A side surface of the connecting portion 37 is exposed from another side surface 1z of the coil substrate 1 and the exposed portion is connected to an electrode of the inductor 100. The connecting portion 37 is integrally formed with the seventh wiring 30₇. The insulating layer 20₇ is stacked on the seventh wiring 30₇, the connecting portion 37 and the insulating layer 40₇. In other words, the seventh structure 1G has a vertically inversed structure of a structure including the insulating layer 20₇, the seventh wiring 30₇ and the connecting portion 37 formed on the insulating layer 20₇, and the insulating layer 40₇ formed on the insulating layer 20₇ such as to cover the seventh wiring 30₇ and the connecting portion 37.

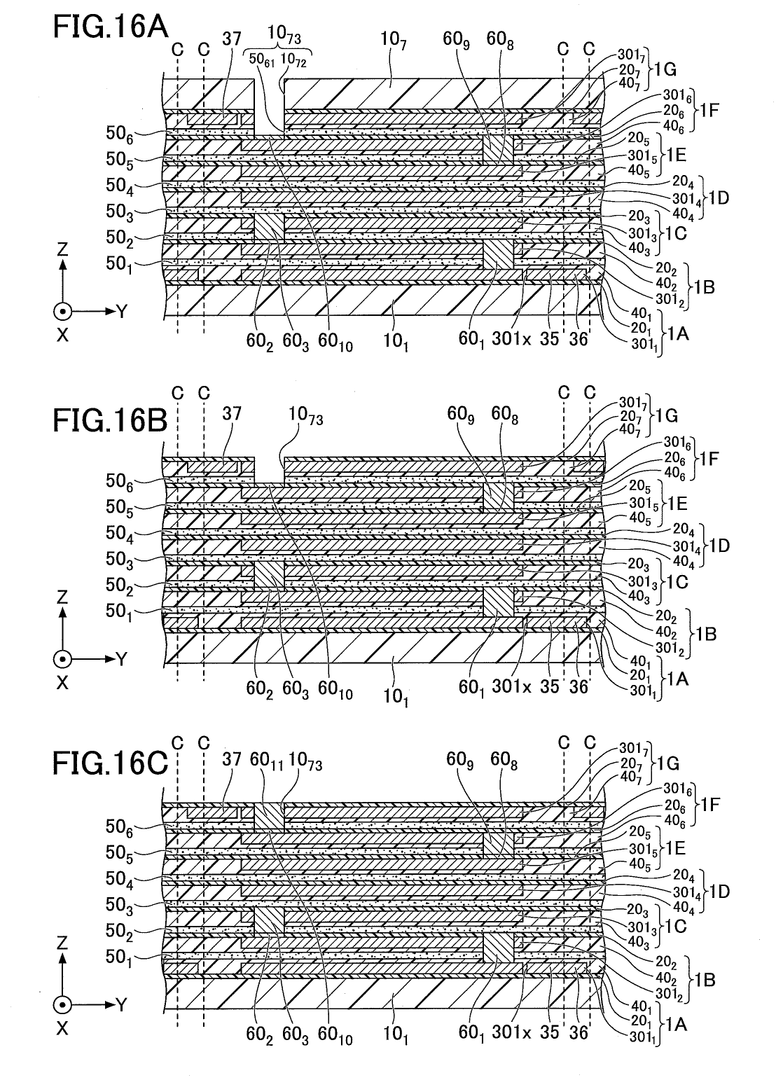

The seventh structure 1G is provided with an open portion that penetrates the insulating layer 20₇, the seventh wiring 30₇ and the insulating layer 40₇ whose lower side is in communication with an open portion of the adhesion layer 50₆. The via wiring 60₁₁ is filled in these open portions (an open portion 10₇₂ illustrated in FIG. 16A). The via wiring 60₁₁ is electrically connected to a via wiring 60₁₀ formed in the open portion of the insulating layer 20₆ of the sixth structure 1F. The seventh wiring 30₇ is electrically connected in series with the sixth wiring 30₆ through the via wirings 60₁₀ and 60₁₁. As such, in the coil substrate 1, the spiral-shaped coil, from the connecting portion 35 to the connecting portion 37, is formed by connecting the wirings of the adjacent structures in series.

The adhesion layer 50₇ is stacked on the seventh structure 1G. The adhesion layer 50₇ is not provided with an open portion. This means that an upper side of the stacked structure in which the first structure 1A to the seventh structure 1G are stacked is covered by the adhesion layer 50₇, which is an insulating layer, and any conductive materials are not exposed.

In the stacked structure in which the first structure 1A to the seventh structure 1G are stacked, surfaces except the bottom surface and the side surfaces 1y and 1z are covered by the insulating film 70. The inner wall surface of the through hole 1x is also covered by the insulating film 70. The insulating film 70 is provided to prevent a short between the end surfaces of the wirings that are exposed from the stacked structure and conductive materials (magnetic filler or the like) that may be included in the sealing resin 110 when manufacturing the inductor 100 (see FIG. 3). For the insulating film 70, epoxy based insulating resin, acrylic based insulating resin or the like may be used, for example. The insulating film 70 may include filler such as silica or the like. The thickness of the insulating film 70 may be about 20 to 50 μm, for example.

FIG. 3 is a cross-sectional view illustrating an example of the inductor 1 of the embodiment. With reference to FIG. 3, the inductor 100 is a chip inductor in which the coil substrate 1 is sealed by the sealing resin 110 and electrodes 120 and 130 are formed. The plan shape of the inductor 100 may be substantially a rectangular shape having a size of about 1.6 mm×0.8 mm. The thickness of the inductor 100 may be about 1.0 mm, for example. The inductor 100 may be used as a voltage conversion circuit or the like of a small-size electronic device, for example.

In the inductor 100, the sealing resin 110 seals the coil substrate 1 except portions at the one side surface 1y and the other side surface 1z. This means that the sealing resin 110 covers the coil substrate 1 except the portions of the side surfaces where the connecting portions 35 and 37 are exposed. The sealing resin 110 is also formed in the through hole 1x. For the sealing resin 110, insulating resin (epoxy based insulating resin or the like, for example) including magnetic filler such as ferrite or the like may be used, for example. The magnetic material has a function to increase the inductance of the inductor 100.

As such, according to the coil substrate 1, as the through hole 1x is provided and the through hole 1x is also filled with the insulating resin such as the epoxy based insulating resin or the like including the magnetic material, the inductance can be improved. Further, a core made of a magnetic material such as ferrite or the like may be provided in the through hole 1x and the core may be also sealed by the sealing resin 110. The shape of the core may be a column shape, a rectangular parallelepiped shape or the like, for example.

The electrode 120 is formed outside the sealing resin 110 and is electrically connected to a part of the connecting portion 35. Specifically, the electrode 120 is continuously formed at the one side surface of the sealing resin 110 and parts of the upper surface and the lower surface of the sealing resin 110. An inner wall surface of the electrode 120 contacts a side surface of the connecting portion 35 that is exposed at the one side surface 1y of the coil substrate 1 and the electrode 120 and the connecting portion 35 are electrically connected with each other.

The electrode 130 is formed outside the sealing resin 110 and is electrically connected to a part of the connecting portion 37. Specifically, the electrode 130 is continuously formed at the side surface of the sealing resin 110 and parts of the upper surface and the lower surface of the sealing resin 110. An inner wall surface of the electrode 130 contacts a side surface of the connecting portion 37 that is exposed at the other side surface 1z of the coil substrate 1 and the electrode 130 and the connecting portion 37 are electrically connected with each other. For the material of the electrodes 120 and 130, copper (Cu), copper alloy or the like may be used, for example. The electrodes 120 and 130 may be formed by coating copper paste, sputtering of copper, electroless plating or the like, for example. The electrodes 120 and 130 may be a stacked structure of a plurality of metal layers.

### (Method of Manufacturing Coil Substrate)

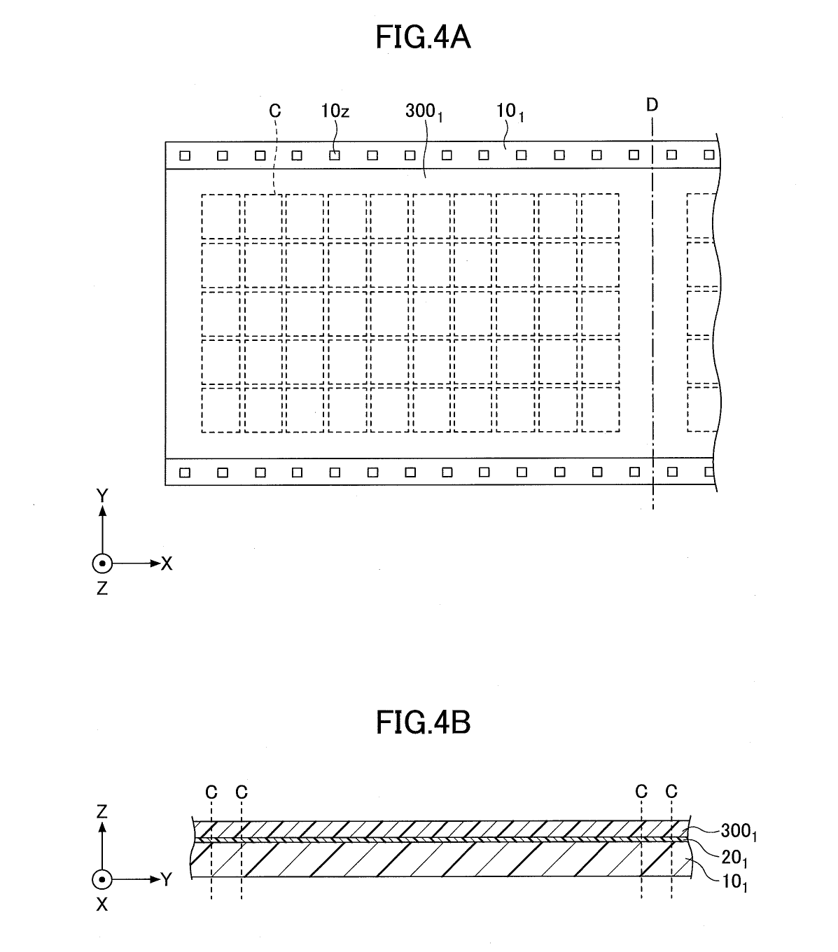

Next, a method of manufacturing the coil substrate of the embodiment is explained. FIG. 4A to FIG. 21C are views illustrating an example of the method of manufacturing the coil substrate of the embodiment. First, steps illustrated in FIG. 4A and FIG. 4B are explained. FIG. 4A is a plan view, and FIG. 4B is a cross-sectional view of FIG. 4A taken along a direction parallel to a Y-Z plane in FIG. 4A in the vicinity of one of individual areas C (which will be explained below). In the steps illustrated in FIG. 4A and FIG. 4B, first, a flexible reel (tape) insulating resin film is prepared as the substrate 10₁ (first substrate).

Then, sprocket holes 10z are continuously formed at both end positions of the substrate 10₁ in a shorter direction (Y direction in FIG. 4A and FIG. 4B) along a longer direction (X direction in FIG. 4A and FIG. 4B) with substantially a same interval, by press working or the like. Thereafter, the insulating layer 20₁ and the metal film 300₁ are formed on one surface of the substrate 10₁ in this order at an area except the both end portions of the substrate 10₁ where the sprocket holes 10z are formed. Specifically, the semi-cured insulating layer 20₁ and the metal film 300₁ are stacked on the one surface of the substrate 10₁ in this order and are heated so that the semi-cured insulating layer 20₁ is cured.

Each area C (referred to as the “individual areas C”) expressed by a dashed line inside the both end portions of the substrate 10₁ where the sprocket holes 10z are formed becomes the coil substrate 1 after finally being cut and individualized along the dashed lines. The plurality of individual areas C is aligned in columns and rows, for example. At this time, the plurality of individual areas C may be aligned with a predetermined space therebetween as illustrated in FIG. 4A, or may be aligned to contact with each other. Further, the number of individual areas C and the number of sprocket holes 10z may be arbitrarily determined. Here, a line expressed by “D” (hereinafter, referred to as cut position D) indicates a cut position along which the reel (tape) substrate 10₁ or the like is cut in the following step.

For the substrate 10₁, polyphenylenesulfide film, polyimide film, polyethylenenaphthalate film or the like may be used, for example. The thickness of the substrate 10₁ may be about 50 to 75 μm, for example.

For the insulating layer 20₁, film epoxy based insulating resin or the like may be used, for example. Alternatively, for the insulating layer 20₁, liquid or paste epoxy based insulating resin or the like may be used. The thickness of the insulating layer 20₁ may be about 8 to 12 μm, for example. The metal film 300₁ becomes the metal layer 301₁ and the connecting portion 35 after being patterned, and may be made of a copper film, for example. The thickness of the metal film 300₁ may be about 12 to 50 μm, for example.

The sprocket holes 10z are used for pitch feeding the substrate 10₁ by being engaged with pins of a sprocket that is driven by a motor or the like when the substrate 10₁ is mounted on a manufacturing apparatus or the like in the course of manufacturing the coil substrate 1. The width (in a direction perpendicular to the alignment direction of the sprocket holes 10z (Y direction)) of the substrate 10₁ is determined to correspond to the manufacturing apparatus on which the substrate 10₁ is mounted.

The width of the substrate 10₁ may be about 40 to 90 mm, for example. On the other hand, the length of the substrate 10₁ (in an alignment direction of the sprocket holes 10z (X direction)) may be arbitrarily determined. For the example illustrated in FIG. 4A, there are individual areas C of 5 rows and 10 columns. However, the substrate 10₁ may be made longer and the individual areas C of about few hundreds columns may be provided, for example.

Next, in steps illustrated in FIG. 5A and FIG. 5B (FIG. 5B is a plan view and FIG. 5A is a cross-sectional view of FIG. 5B taken along an A-A line in FIG. 5B), the first structure 1A is formed in which metal layer 301₁ is formed on the substrate 10₁. The metal layer 301₁ becomes the first wiring 30₁ that is the first layer wiring and is a part (about a roll) of the coil after finally shaped (by die cutting or the like).

Specifically, the metal layer 301₁ is formed on the insulating layer 20₁ by patterning the metal film 300₁ illustrated in FIG. 4B. Further, at this time, the connecting portion 35 is formed at the one end portion of the metal layer 301₁. Further, at this time, a bus line 36 connected to the connecting portion 35 is formed. The bus line 36 is used for power supply in electroplating in the following steps and is electrically connected to the metal layer 301₁ and the connecting portion 35 of each of the individual areas C. If the electroplating is not performed in the following steps, the bus line 36 may not be formed. The metal layer 301₁ is provided with a slit portion 301x. The slit portion 301x is provided to facilitate forming a spiral shape of the coil when shaping (die cutting or the like) the coil substrate 1.

The metal film 300₁ may be patterned by photolithography, for example. This means that the metal film 300₁ may be patterned by forming photosensitive resist on the metal film 300₁, forming an open portion in the photosensitive resist by exposing and developing a predetermined area, and removing the metal film 300₁ that is exposed in the open portion by etching. The metal layer 301₁, the connecting portion 35 and the bus line 36 are integrally formed.

Thereafter, the metal layer 301₁, the connecting portion 35 and the bus line 36 are covered by the insulating layer 40₁. The insulating layer 40₁ may be formed by laminating a film photosensitive epoxy based insulating resin or the like. Alternatively, the insulating layer 40₁ may be formed by coating liquid or paste photosensitive epoxy based insulating resin or the like. The thickness of the insulating layer 40₁ (the thickness from the upper surface of the metal layer 301₁) may be about 5 to 30 μm, for example.

Thereafter, the open portion 40₁₁ is formed in the insulating layer 40₁ of the first structure 1A that exposes the upper surface of the metal layer 301₁. The plan shape of the open portion 40₁₁ may be a circular shape whose diameter is about 150 μm. The open portion 40₁₁ may be formed by press working, laser processing or the like, for example. The open portion 40₁₁ may be formed by exposing and developing the photosensitive insulating layer 40₁. In FIG. 5B, the insulating layer 40₁ is not illustrated. In FIG. 5B, an area of the metal layer 301₁ corresponding to the open portion 40₁₁ is illustrated by a dashed line.

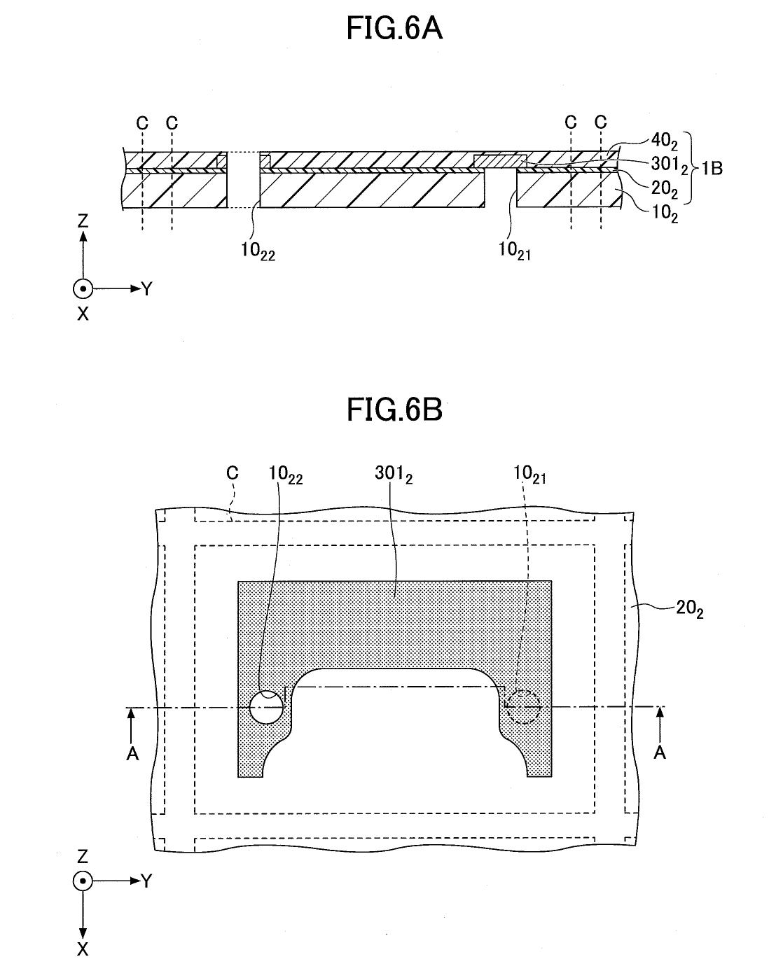

Next, in steps illustrated in FIG. 6A and FIG. 6B (FIG. 6B is a plan view and FIG. 6A is a cross-sectional view of FIG. 6B taken along an A-A line in FIG. 6B), the second structure 1B is formed in which the metal layer 301₂ is formed on the substrate 10₂ (second substrate). The metal layer 301₂ becomes the second wiring 30₂ that is the second layer wiring and is a part (about ¾ roll) of the coil after finally shaped (by die cutting or the like). Specifically, after forming the sprocket holes 10z, similar to the step illustrated in FIG. 4A and FIG. 4B, the insulating layer 20₂ and the metal film 300₂ (not illustrated in the drawings) are formed on the substrate 10₂ in this order at an area except the both end portions of the substrate 10₂ where the sprocket holes 10z are formed.

Then, similar to the steps illustrated in FIG. 5A and FIG. 5B, the metal film 300₂ is patterned and the metal layer 301₂ patterned as illustrated in FIG. 6B is formed on the insulating layer 20₂. Thereafter, the metal layer 301₂ is covered by the insulating layer 40₂. Then, the open portion 10₂₁ is formed in the substrate 10₂ and the insulating layer 20₂ of the second structure 1B that exposes the lower surface of the metal layer 301₂. Further, the open portion 10₂₂ (through hole) is formed that penetrates the substrate 10₂, and the insulating layer 20₂, the metal layer 301₂ and the insulating layer 40₂ of the second structure 1B.

The plan shape of each of the open portions 10₂₁ and 10₂₂ may be a circular shape whose diameter is about 150 μm. The open portions 10₂₁ and 10₂₂ may be formed by press working, laser processing or the like. The open portion 10₂₂ is formed at a position that overlaps the open portion 40₁₁ in a plan view when the first structure 1A and the second structure 1B are stacked with each other in a predetermined direction. Further, in FIG. 6B, the insulating layer 40₂ is not illustrated. Further, in FIG. 6B, an area of the metal layer 301₂ corresponding to the open portion 10₂₁ is illustrated by a dashed line.

The shape, the thickness, the material and the like of the substrate 10n and the metal film 300ₙ (here, “n” is a natural number more than or equal to 2) are the same as those of the substrate 10₁ and the metal film 300₁ unless otherwise explained.

Next, steps illustrated in FIG. 7A to FIG. 7C are explained. FIG. 7A to FIG. 7C are cross-sectional views corresponding to FIG. 5A and FIG. 6A. First, in a step illustrated in FIG. 7A, the adhesion layer 50₁ is prepared and the open portion 50₁₁ (through hole) that penetrates the adhesion layer 50₁ is formed. The open portion 50₁₁ may be formed at a position that overlaps the open portions 40₁₁ and 10₂₂ in a plan view when the first structure 1A and the second structure 1B are stacked with each other through the adhesion layer 50₁ in the predetermined direction. For the adhesion layer 50₁, heat resistance adhesive (thermosetting) made of insulating resin such as epoxy based adhesive, polyimide based adhesive or the like may be used, for example. The thickness of the adhesion layer 50₁ may be about 10 to 40 μm, for example.

Next, the substrate 10₂ and the second structure 1B are reversed from the state illustrated in FIG. 6A, and are stacked on the first structure 1A through the adhesion layer 50₁. This means that the first structure 1A and the second structure 1B are faced to be stacked while interposing the adhesion layer 50₁ such that the substrate 10₁ and the substrate 10₂ are positioned, outside. Thereafter, the adhesion layer 50₁ is cured. At this time, as the open portion 40₁₁, the open portion 50₁₁ and the open portion 10₂₂ are in communication with each other, a single open portion 10₂₃ is formed and the upper surface of the metal layer 301₁ is exposed at a bottom portion.

Alternatively, in the steps illustrated in FIG. 6A to FIG. 7A, the second structure 1B may be stacked on the first structure 1A through the adhesion layer 50₁ before forming the open portions, and thereafter, the open portions 10₂₁, 10₂₂ and 50₁₁ may be provided.

Next, in a step illustrated in FIG. 7B, the substrate 10₂ is removed (peeled) from the insulating layer 20₂ of the second structure 1B. The substrate 10₂ may be mechanically removed from the insulating layer 20₂ of the second structure 1B.

Next, in a step illustrated in FIG. 7C, the via wiring 60₁ made of copper (Cu) or the like, for example, is formed on the metal layer 301₁ that is exposed at the bottom portion of the open portion 10₂₃. The metal layer 301₁ and the metal layer 301₂ are electrically connected in series through the via wiring 60₁. Further, the via wiring 60₂ made of copper (Cu) or the like, for example, is formed on the metal layer 301₂ that is exposed at a bottom portion of the open portion 10₂₁. The metal layer 301₂ and the via wiring 60₂ are electrically connected with each other.

The via wirings 60₁ and 60₂ may be formed by depositing copper (Cu) or the like from the metal layers 301₁ and 301₂ sides by electroplating in which the bus line 36 is used for supplying power, for example. Further, the via wirings 60₁ and 60₂ may be formed by filling metal paste of copper (Cu) or the like on the metal layer 301₁ that is exposed at the bottom portion of the open portion 10₂₃ and also filling the metal paste of copper (Cu) or the like on the metal layer 301₂ that is exposed at the bottom portion of the open portion 10₂₁. The upper surfaces of the via wirings 60₁ and 60₂ may be flush with the upper surface of the insulating layer 20₂. With this process, in the stacked structure in which the second structure 1B is stacked on the first structure 1A, the metal layer 301₁, the via wiring 60₁ and the metal layer 301₂ are electrically connected in series. Those connected parts become the coil of about one and ¾ rolls after finally shaped (by die cutting or the like).

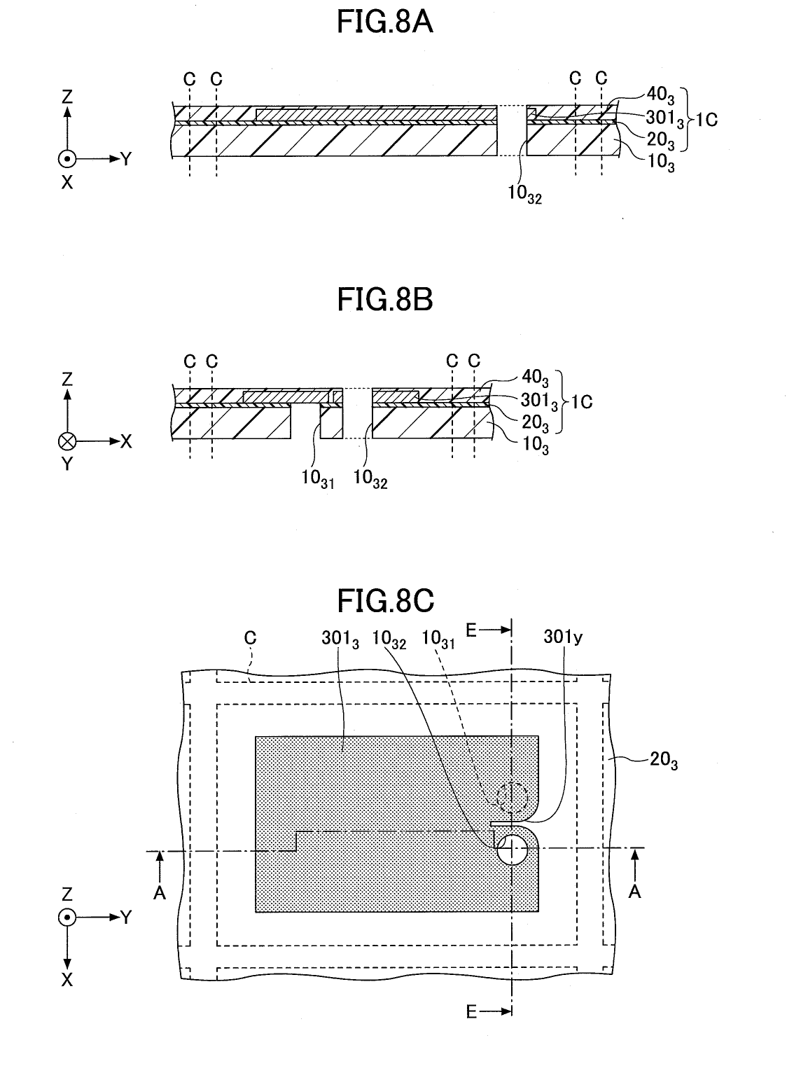

Next, in steps illustrated in FIG. 8A to FIG. 8C, similar to the steps illustrated in FIG. 6A and FIG. 6B, the third structure 1C is formed in which the metal layer 301₃ is formed on the substrate 10₃. FIG. 8C is a plan view, FIG. 8A is a cross-sectional view of FIG. 8C taken along an A-A line in FIG. 8C and FIG. 8B is a cross-sectional view of FIG. 8C taken along an E-E line in FIG. 8C. The metal layer 301₃ becomes the third wiring 30₃ that is the third layer wiring and is a part (about a roll) of the coil after finally shaped (by die cutting or the like). The metal layer 301₃ is provided with a slit portion 301y. The slit portion 301y is provided to facilitate forming the spiral shape of the coil when shaping (die cutting or the like) the coil substrate 1 in the following step.

Next, the open portion 10₃₁ is formed in the substrate 10₃ and the insulating layer 20₃ of the third structure 1C that exposes the lower surface of the metal layer 301₃. Further, the open portion 10₃₂ (through hole) is formed that penetrates the substrate 10₃, and the insulating layer 20₃, the metal layer 301₃ and the insulating layer 40₃ of the third structure 1C.

The plan shape and the method of forming the open portions 10₃₁ and 10₃₂ may be the same as those of the open portion 10₂₁ or the like, for example. The open portion 10₃₂ is formed at a position that overlaps the open portion 10₂₁ in a plan view when the second structure 12 and the third structure 1C are stacked with each other in the predetermined direction. The insulating layer 40₃ is not illustrated in FIG. 8C. Further, in FIG. 8C, an area of the metal layer 301₃ corresponding to the open portion 10₃₁ is illustrated by a dashed line.

Next, steps illustrated in FIG. 9A to FIG. 9C are explained. FIG. 9A to FIG. 9C are cross-sectional views corresponding to FIG. 7C. First, in a step illustrated in FIG. 9A, the adhesion layer 50₂ is prepared and the open portion 50₂₁ (through hole) that penetrates the adhesion layer 50₂ is formed. The open portion 50₂₁ is formed at a position that overlaps the via wiring 60₂ in a plan view when the second structure 1B and the third structure 1C are stacked with each other through the adhesion layer 50₂ in the predetermined direction. The shape, the thickness, the material and the like of an adhesion layer 50n (here, “n” is a natural number more than or equal to 2) are the same as those of the adhesion layer 50₁ unless otherwise explained.

Next, the substrate 10₃ and the third structure 1C are reversed from the state illustrated in FIG. 8A, and are stacked on the second structure 1B through the adhesion layer 50₂. This means that the second structure 1B and the third structure 1C are faced to be stacked while interposing the adhesion layer 50₂ such that the substrate 10₁ and the substrate 10₃ are positioned outside. Thereafter, the adhesion layer 50₂ is cured. At this time, as the open portion 50₂₁ and the open portion 10₃₂ are in communication with each other, a single open portion 10₃₃ is formed and the upper surface of the via wiring 60₂ is exposed at a bottom portion.

Alternatively, in the steps illustrated in FIG. 8A to FIG. 9A, the third structure 1C may be stacked on the second structure 1B through the adhesion layer 50₂ before forming the open portions, and thereafter, the open portions 10₃₁, 10₃₂ and 50₂₁ may be provided.

Next, in a step illustrated in FIG. 9B, the substrate 10₃ is removed (peeled) from the insulating layer 20₃ of the third structure 1C.

Next, in a step illustrated in FIG. 9C, the via wiring 60₃ is formed on the via wiring 60₂ that is exposed at the bottom portion of the open portion 10₃₃. The metal layer 301₂ and the metal layer 301₃ are electrically connected in series through the via wirings 60₂ and 60₃. Further, the via wiring 60₄ (not illustrated in the drawings) is formed on the metal layer 301₃ that is exposed at the bottom portion of the open portion 10₃₁ (not illustrated in the drawings). The metal layer 301₃ and the via wiring 60₄ are electrically connected with each other.

The via wirings 60₃ and 60₄ may be formed by electroplating in which the bus line 36 is used for supplying power or by filling metal paste, similar to the via wiring 60₁. For the material of the via wirings 60₃ and 60₄, copper (Cu) or the like may be used, for example. The upper surfaces of the via wirings 60₃ and 60₄ may be flush with the upper surface of the insulating layer 20₃. With this process, in the stacked structure in which the first structure 1A to the third structure 1C are stacked, the metal layers 301₁, 301₂ and 301₃ are electrically connected in series through the via wirings. Those connected parts become the coil of about two and ¾ rolls after finally shaped (by die cutting or the like).

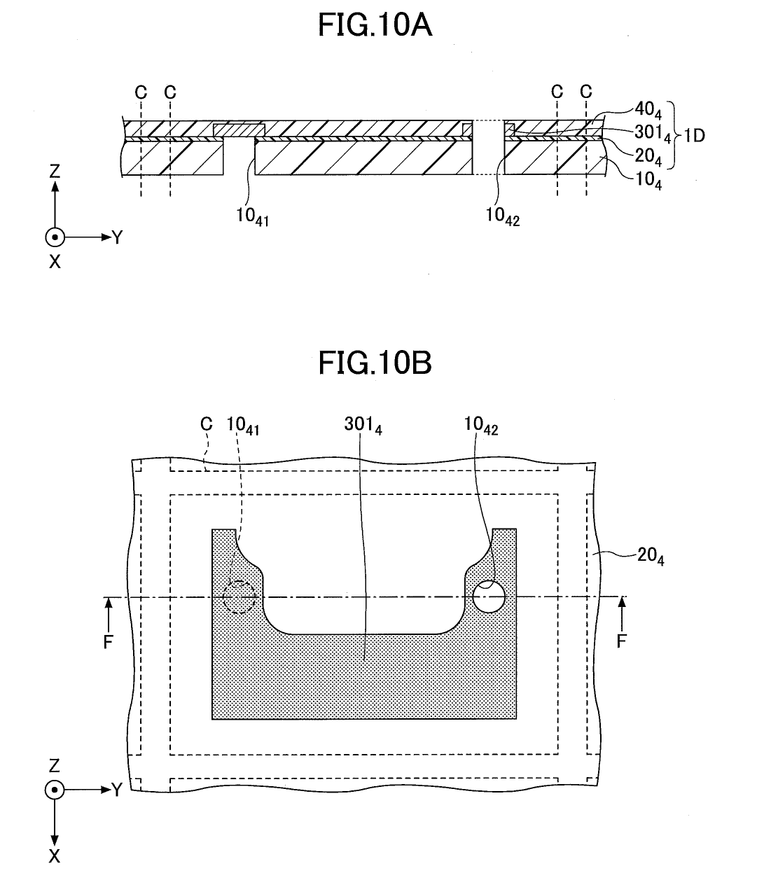

Next, in steps illustrated in FIG. 10A and FIG. 10B (FIG. 10B is a plan view and FIG. 10A is a cross-sectional view of FIG. 10B taken along an F-F line in FIG. 10B), similar to the steps illustrated in FIG. 6A and FIG. 6B, the fourth structure 1D is formed in which the metal layer 301₄ is formed on the substrate 10₄. The metal layer 301₄ becomes the fourth wiring 30₄ that is the fourth layer wiring and is a part (about ¾ roll) of the coil after finally shaped (by die cutting or the like).

Next, the open portion 10₄₁ is formed in the substrate 10₄ and the insulating layer 20₄ of the fourth structure 1D that exposes the lower surface of the metal layer 301₄. Further, the open portion 10₄₂ (through hole) is formed that penetrates the substrate 10₄, and the insulating layer 20₄, the metal layer 301₄ and the insulating layer 40₄ of the fourth structure 1D.

The plan shape and the method of forming the open portions 10₄₁ and 10₄₂ may be the same as those of the open portion 10₂₁ or the like. The open portion 10₄₂ is formed at a position that overlaps the via wiring 60₄ in a plan view when the third structure 1C and the fourth structure 1D are stacked with each other in the predetermined direction. Here, the insulating layer 40₄ is not illustrated in FIG. 10B. Further, in FIG. 10B, an area corresponding to the open portion 10₄₁ of the metal layer 301₄ are illustrated by a dashed line.

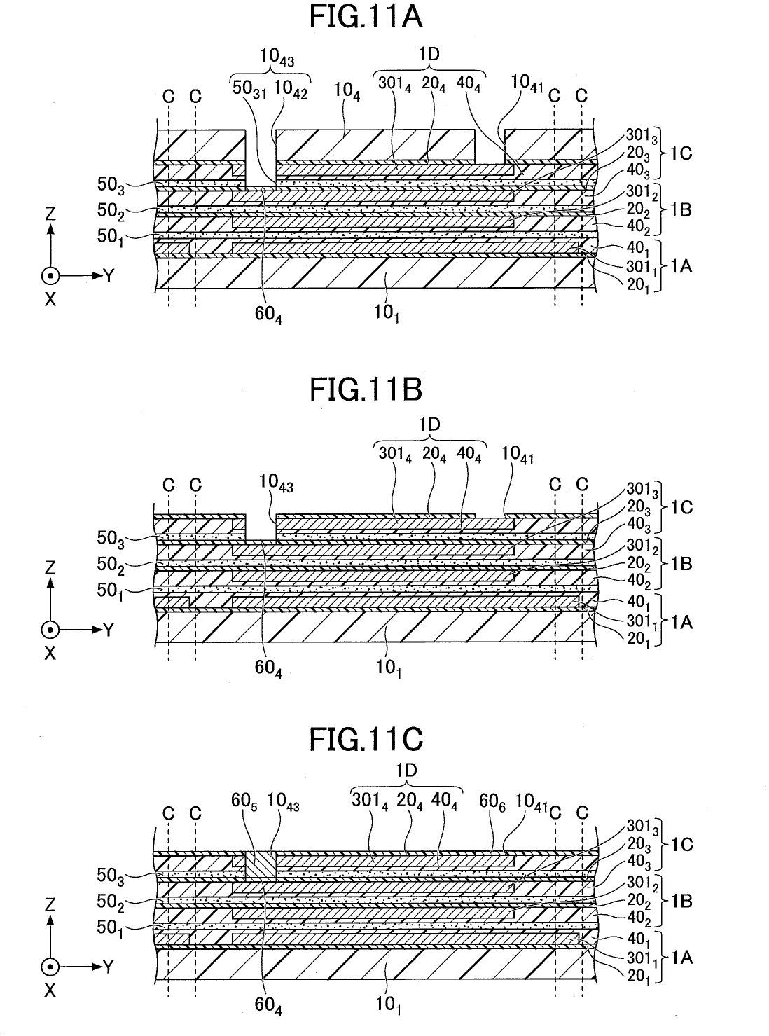

Next, steps illustrated in FIG. 11A to FIG. 11C are explained. FIG. 11A to FIG. 11C are cross-sectional views corresponding to FIG. 9C and FIG. 10A. First, in a step illustrated in FIG. 11A, the adhesion layer 50₃ is prepared, and the open portion 50₃₁ (through hole) that penetrates the adhesion layer 50₃ is formed. The open portion 50₃₁ is formed at a position that overlaps the via wiring 60₄ in a plan view when the third structure 1C and the fourth structure 1D are stacked with each other through the adhesion layer 50₃ in the predetermined direction.

Next, the substrate 10₄ and the fourth structure 1D are reversed from the state illustrated in FIG. 10A, and are stacked on the third structure 10 through the adhesion layer 50₃. This means that the third structure 1C and the fourth structure 1D are faced to be stacked while interposing the adhesion layer 50₃ such that the substrate 10₁ and the substrate 10₄ are positioned outside. Thereafter, the adhesion layer 50₃ is cured. At this time, as the open portion 50₃₁ and the open portion 10₄₂ are in communication with each other, a single open portion 10₄₃ is formed and the upper surface of the via wiring 60₄ is exposed at a bottom portion.

Alternatively, in the steps illustrated FIG. 10A to FIG. 11A, the fourth structure 1D may be stacked on the third structure 1C through the adhesion layer 50₃ before forming the open portions, and thereafter, the open portions 10₄₁, 10₄₂ and 50₃₁ may be formed.

Next, in a step illustrated in FIG. 11B, the substrate 10₄ is removed (peeled) from the insulating layer 20₄ of the fourth structure 1D.

Next, in a step illustrated in FIG. 11C, the via wiring 60₅ is formed on the via wiring 60₄ that is exposed at the bottom portion of the open portion 10₄₃. The metal layer 301₃ and the metal layer 301₄ are electrically connected in series through the via wirings 60₄ and 60₅. Further, the via wiring 60₆ is formed on the metal layer 301₄ that is exposed at the bottom portion of the open portion 10₄₁. The metal layer 301₄ and the via wiring 60₆ are electrically connected with each other.

The via wirings 60₅ and 60₆ may be formed by electroplating in which the bus line 36 is used for supplying power or by filling metal paste, similar to the via wiring 60₁ or the like. For the material of the via wirings 60₅ and 60₅, copper (Cu) or the like may be used, for example. The upper surfaces of the via wirings 60₅ and 60₆ may be flush with the upper surface of the insulating layer 20₄. With this process, in the stacked structure in which the first structure 1A to the fourth structure 1D are stacked, the metal layers 301₁, 301₂, 301₃ and 301₄ are electrically connected in series through the via wirings. Those connected parts become the coil of about three rolls after finally shaped (by die cutting or the like).

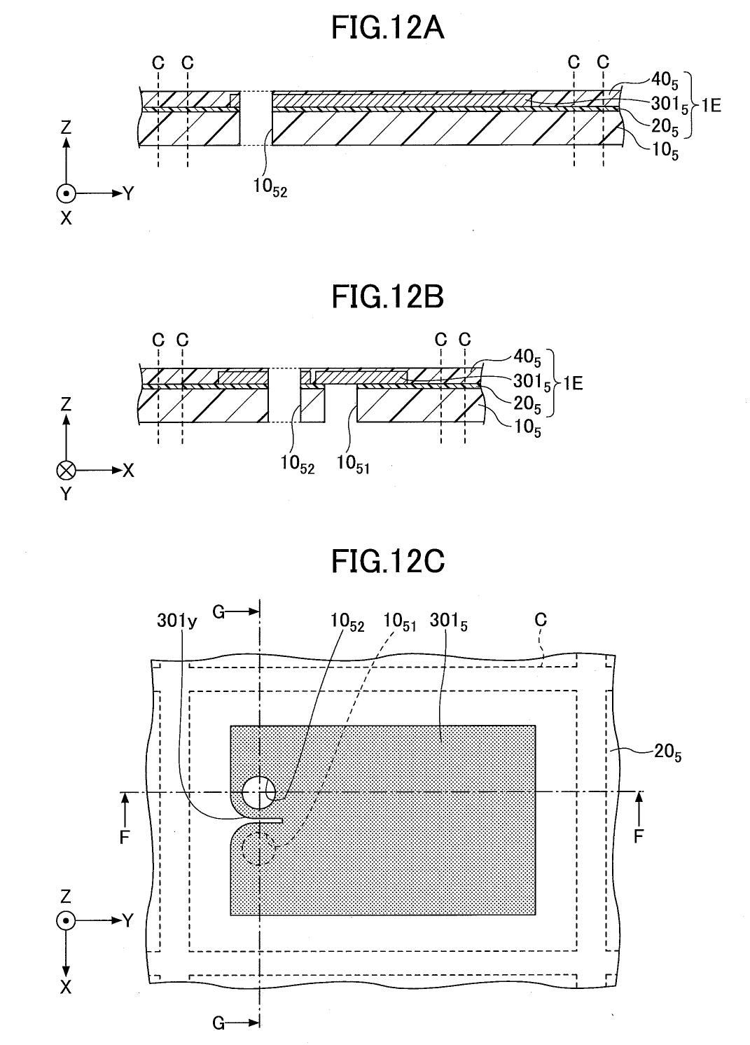

Next, in steps illustrated in FIG. 12A to FIG. 12C, similar to the steps illustrated in FIG. 6A and FIG. 6B, the fifth structure 1E is formed in which the metal layer 301₅ is formed on the substrate 10₅. FIG. 12C is a plan view, FIG. 12A is a cross-sectional view of FIG. 12C taken along an F-F line in FIG. 12C, and FIG. 12B is a cross-sectional view of FIG. 12C taken along a G-G line in FIG. 12C. The metal layer 301₅ becomes the fifth wiring 30₅ that is the fifth layer wiring and a part (about a roll) of the coil after finally shaped (by die cutting or the like). The metal layer 301₅ is provided with a slit portion 301y. The slit portion 301y is provided to facilitate forming the spiral shape of the coil when shaping (die cutting or the like) the coil substrate 1 in the following step.

Next, the open portion 10₅₁ is formed in the substrate 10₅ and the insulating layer 20₅ of the fifth structure 1E that exposes the lower surface of the metal layer 301₅. Further, the open portion 10₅₂ (through hole) is formed that penetrates the substrate 10₅, and the insulating layer 20₅, the metal layer 301₅ and the insulating layer 40₅ of the fifth structure 1E.

The plan shape and the method of forming the open portions 10₅₁ and 10₅₂ may be the same as those of the open portion 10₂₁ or the like, for example. The open portion 10₅₂ is formed at a position that overlaps the open portion 50₄₁ in a plan view when the fourth structure 1D and the fifth structure 1E are stacked with each other in the predetermined direction. The insulating layer 40₅ is not illustrated in FIG. 12C. Further, in FIG. 12C, an area corresponding to the open portion 10₅₁ of the metal layer 301₅ is illustrated by a dashed line.

Next, steps illustrated in FIG. 13A to FIG. 13C are explained. FIG. 13A to FIG. 13C are cross-sectional views corresponding to FIG. 11C and FIG. 12A. First, in a step illustrated in FIG. 13A, the adhesion layer 50₄ is prepared and the open portion 50₄₁ (through hole) that penetrates the adhesion layer 50₄ is formed. The open portion 50₄₁ is formed at a position that overlaps the via wiring 60₆ in a plan view when the fourth structure 1C and the fifth structure 1E are stacked with each other through the adhesion layer 50₄ in the predetermined direction.

Next, the substrate 10₅ and the fifth structure 1E are reversed from the state illustrated in FIG. 12A, and are stacked on the fourth structure 1D vie the adhesion layer 50₄. This means that the fourth structure 1D and the fifth structure 1E are faced to be staked while interposing the adhesion layer 50₄ such that the substrate 10₁ and the substrate 10₅ are positioned outside. Thereafter, the adhesion layer 50₄ is cured. At this time, as the open portion 50₄₁ and the open portion 10₅₂ are in communication with each other, a single open portion 10₅₃ is formed and the upper surface of the via wiring 60₆ is exposed at a bottom portion.

Alternatively, in the steps illustrated in FIG. 12A to FIG. 13A, the fifth structure 1E may be stacked on the fourth structure 1D through the adhesion layer 50₄ before forming the open portions, and thereafter, the open portions 10₅₁, 10₅₂ and 50₄₁ may be formed.

Next, in a step illustrated in FIG. 13B, the substrate 10₅ is removed (peeled) from the insulating layer 20₅ of the fifth structure 1E.

Next, in a step illustrated in FIG. 13C, the via wiring 60₇ is formed on the via wiring 60₆ that is exposed at the bottom portion of the open portion 10₅₃. The metal layer 301₅ and the metal layer 301₄ are electrically connected in series through the via wirings 60₆ and 60₇. Further, the via wiring 60₈ (not illustrated in the drawings) is formed on the metal layer 301₅ that is exposed at the bottom portion of the open portion 10₅₁ (not illustrated in the drawings). The metal layer 301₅ and the via wiring 60₈ are electrically connected with each other.

The via wirings 60₇ and 60₈ may be formed by electroplating in which the bus line 36 is used for supplying power or by filling metal paste, similar to the via wiring 60₁ or the like. For the material of the via wirings 60₇ and 60₈, copper (Cu) or the like may be used, for example. The upper surfaces of the via wirings 60₇ and 60₈ may be flush with the upper surface of the insulating layer 20₅. With this process, in the stacked structure in which the first structure 1A to the fifth structure 1E are stacked, the metal layers 301₁, 301₂, 301₃, 301₄ and 301₅ are electrically connected in series through the via wirings. Those connected parts become the coil of about four rolls after finally shaped (by die cutting or the like).

Next, steps illustrated in FIG. 14A to FIG. 14C are explained. FIG. 14A to FIG. 14C are cross-sectional views corresponding to FIG. 13C. First, in a step illustrated in FIG. 14A, the sixth structure 1F is formed in which the metal layer 301₆ is formed on the substrate 10₆. The metal layer 301₆ becomes the sixth wiring 30₆ that is the sixth layer wiring and is a part (about ¾ roll) of the coil after finally shaped (by die cutting or the like). Then, the open portion 10₆₁ is formed in the substrate 10₆ and the insulating layer 20₆ of the sixth structure 1F that exposes the lower surface of the metal layer 301₆. Further, the open portion 10₆₂ (through hole) is formed that penetrates the substrate 10₆, and the insulating layer 20₆, the metal layer 301₆ and the insulating layer 40₆ of the sixth structure 1F. Although the reference numerals are different in the sixth structure 1F and the second structure 1B, the sixth structure 1F has the same structure as the second structure 1B and the open portions 10₆₁ and 10₆₂ respectively correspond to the open portions 10₂₁ and 10₂₂.

Next, the adhesion layer 50₅ is prepared and the open portion 50₅₁ (through hole) is formed that penetrates the adhesion layer 50₅. The open portion 50₅₁ is formed at a position that overlaps the via wiring 60₈ in a plan view when the sixth structure 1F and the fifth structure 1E are stacked with each other through the adhesion layer 50₅ in the predetermined direction. Then, similar to FIG. 7A, the substrate 10₆ and the sixth structure 1F are reversed from the state illustrated in FIG. 6A, and are stacked on the fifth structure 1E through the adhesion layer 50₅. This means that the fifth structure 1E and the sixth structure 1F are faced to be stacked while interposing the adhesion layer 50₅ such that the substrate 10₁ and the substrate 10₆ are positioned outside. Thereafter, the adhesion layer 50₅ is cured. At this time, as the open portion 50₅₁ and the open portion 10₆₂ are in communication with each other, a single open portion 10₆₃ is formed and the upper surface of the via wiring 60₈ is exposed at a bottom portion.

Alternatively, in the steps illustrated in FIG. 6A, FIG. 6B and FIG. 14A, the sixth structure 1F may be stacked on the fifth structure 1E through the adhesion layer 50₅ before forming the open portions, and thereafter, the open portions 10₆₁, 10₆₂ and 50₅₁ may be formed.

Next, in a step illustrated in FIG. 14B, the substrate 10₆ is removed (peeled) from the insulating layer 20₆ of the sixth structure 1F.

Next, in a step illustrated in FIG. 14C, the via wiring 60₉ is formed on the via wiring 60₈ that is exposed at the bottom portion of the open portion 10₆₃. The metal layer 301₅ and the metal layer 301₆ are electrically connected in series through the via wirings 60₈ and 60₉. Further, the via wiring 60₁₀ is formed on the metal layer 301₆ that is exposed at the bottom portion of the open portion 10₆₁. The metal layer 301₆ and the via wiring 60₁₀ are electrically connected with each other.

The via wirings 60₉ and 60₁₀ may be formed by electroplating in which the bus line 36 is used for supplying power or by filling metal paste, similar to the via wiring 60₁ or the like. For the material of the via wirings 60₉ and 60₁₀, copper (Cu) or the like may be used, for example. The upper surfaces of the via wirings 60₉ and 60₁₀ may be flush with the upper surface of the insulating layer 20₆. With this process, in the stacked structure in which the first structure 1A to the sixth structure 1F are stacked, the metal layers 301₁, 301₂, 301₃, 301₄, 301₅ and 301₆ are electrically connected in series through the via wirings. Those connected parts become the coil of about four and ¾ rolls after finally shaped (by die cutting or the like).

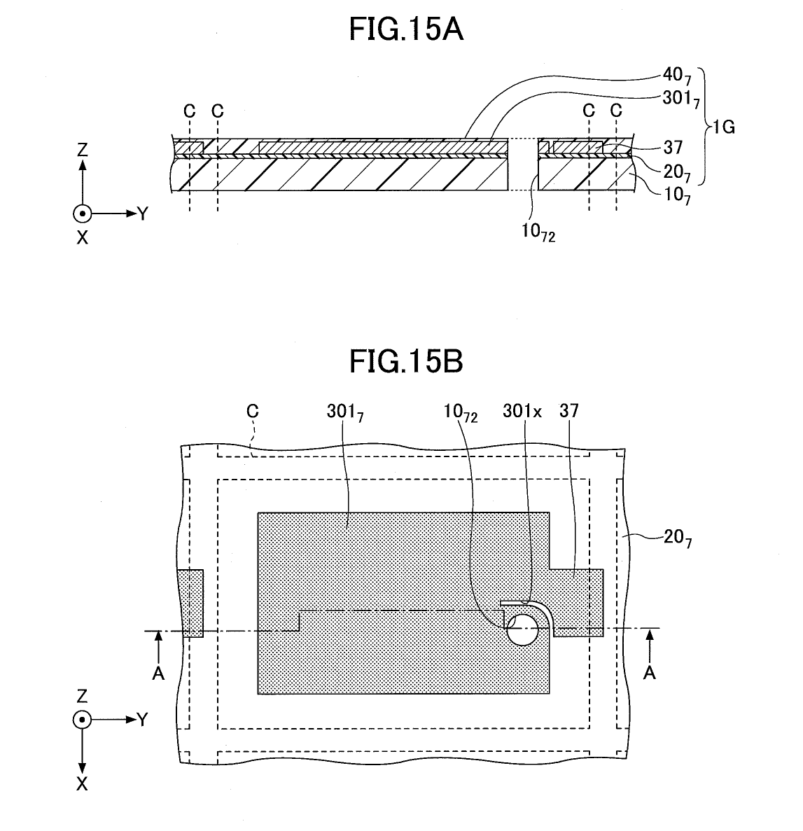

Next, in steps illustrated in FIG. 15A and FIG. 15B, similar to the steps illustrated in FIG. 6A and FIG. 6B, the seventh structure 1G is formed in which the metal layer 301₇ is formed on the substrate 10₇. The metal layer 301₇ becomes the seventh wiring 30₇ that is the seventh layer wiring and is a part (about a roll) of the coil after finally shaped (by die cutting or the like). Specifically, the metal layer 301₇ is formed on the insulating layer 20₇. Further, the connecting portion 37 is formed at one end portion of the metal layer 301₇. The metal layer 301₇ and the connecting portion 37 are integrally formed. The metal layer 301₇ is provided with a slit portion 301x. The slit portion 301x is provided to facilitate forming the spiral shape of the coil when shaping (die cutting or the like) the coil substrate 1 in the following step.

Next, the open portion 10₇₂ (through hole) is formed that penetrates the substrate 10₇, and the insulating layer 20₇, the metal layer 301₇ and the insulating layer 40₇ of the seventh structure 1G. FIG. 15B is a plan view and FIG. 15A is a cross-sectional view of FIG. 15B taken along an A-A line of FIG. 15B. The plan shape and the method of forming the open portion 10₇₂ may be the same as those of the open portion 10₂₁ or the like, for example. The open portion 10₇₂ is formed at a position that overlaps the via wiring 60₁₀ in a plan view when the sixth structure 1E and the seventh structure 1G are stacked with each other in the predetermined direction. The insulating layer 40₇ is not illustrated in FIG. 15B.

Next, steps illustrated in FIG. 16A to FIG. 16C are explained. FIG. 16A to FIG. 16C are cross-sectional views corresponding to FIG. 14C and FIG. 15A. First, in a step illustrated in FIG. 16A, the adhesion layer 50₆ is prepared and the open portion 50₆₁ (through hole) that penetrates the adhesion layer 50₆ is formed. The open portion 50₆₁ is formed at a position that overlaps the via wiring 60₁₀ in a plan view when the sixth structure 1F and the seventh structure 1G are stacked with each other through the adhesion layer 50₆ in the predetermined direction.

Next, the substrate 10₇ and the seventh structure 1G are reversed from the state illustrated in FIG. 15A, and are stacked on the sixth structure 1F through the adhesion layer 50₆. This means that the sixth structure 1F and the seventh structure 1G are faced to be staked while interposing the adhesion layer 50₆ such that the substrate 10₁ and the substrate 10₇ are positioned outside. Thereafter, the adhesion layer 50₆ is cured. At this time, as the open portion 50₆₁ and the open portion 10₇₂ are in communication with each other, a single open portion 10₇₃ is formed and the upper surface of the via wiring 60₁₀ is exposed at a bottom portion.

Alternatively, in the steps illustrated in FIG. 15A to FIG. 16A, the seventh structure 1G may be stacked on the sixth structure 1F through the adhesion layer 50₆ before forming the open portions, and thereafter, the open portions 10₇₂ and 50₆₁ may be formed.

Next, in a step illustrated in FIG. 162, the substrate 10₇ is removed (peeled) from the insulating layer 20₇ of the seventh structure 1G.

Next, in a step illustrated in FIG. 16C, the via wiring 60₁₁ is formed on the via wiring 60₁₀ that is exposed at the bottom portion of the open portion 10₇₃. The metal layer 301₆ and the metal layer 301₇ are electrically connected in series through the via wirings 60₁₀ and 60₁₁.

The via wiring 60₁₁ may be formed by electroplating in which the bus line 36 is used for supplying power or by filling metal paste, similar to the via wiring 60₁ or the like. For the material of the via wiring 60₁₁, copper (Cu) or the like may be used, for example. The upper surface of the via wiring 60₁₁ may be flush with the upper surface of the insulating layer 20₇. With this process, in the stacked structure in which the first structure 1A to the seventh structure 1G are stacked, the metal layers 301₁, 301₂, 301₃, 301₄, 301₅, 301₆ and 301₇ are connected in series through the via wirings. Those connected parts become the coil of about five and ½ rolls after finally shaped (by die cutting or the like).

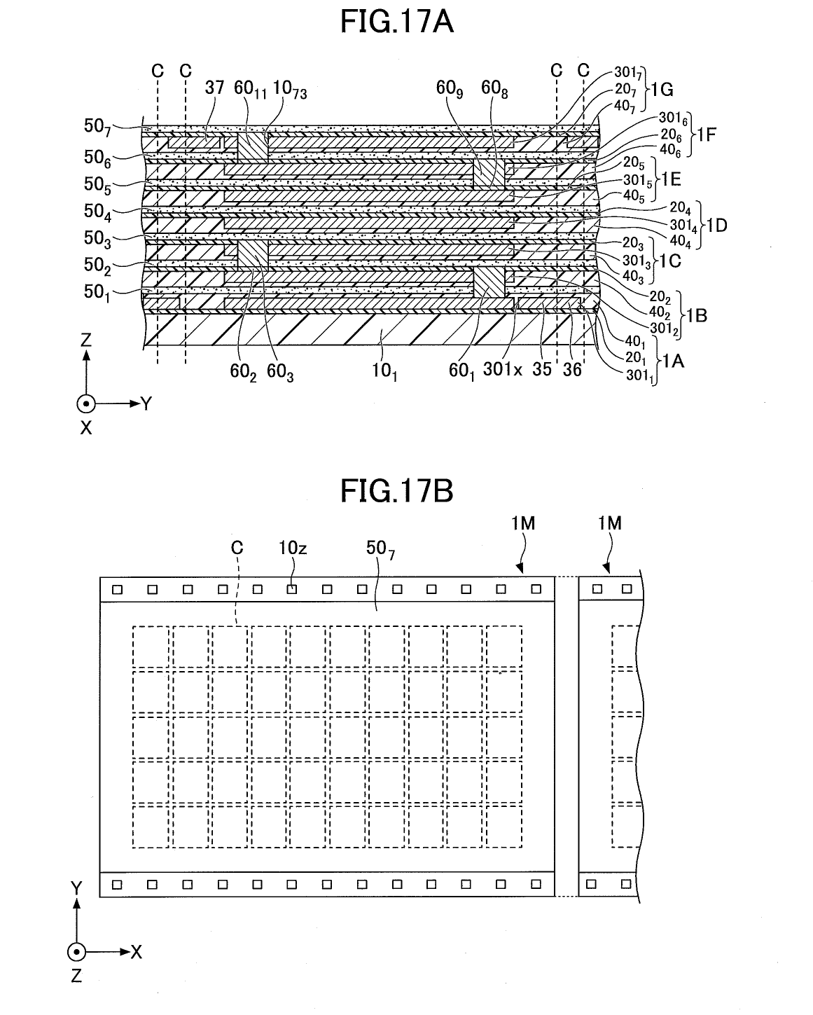

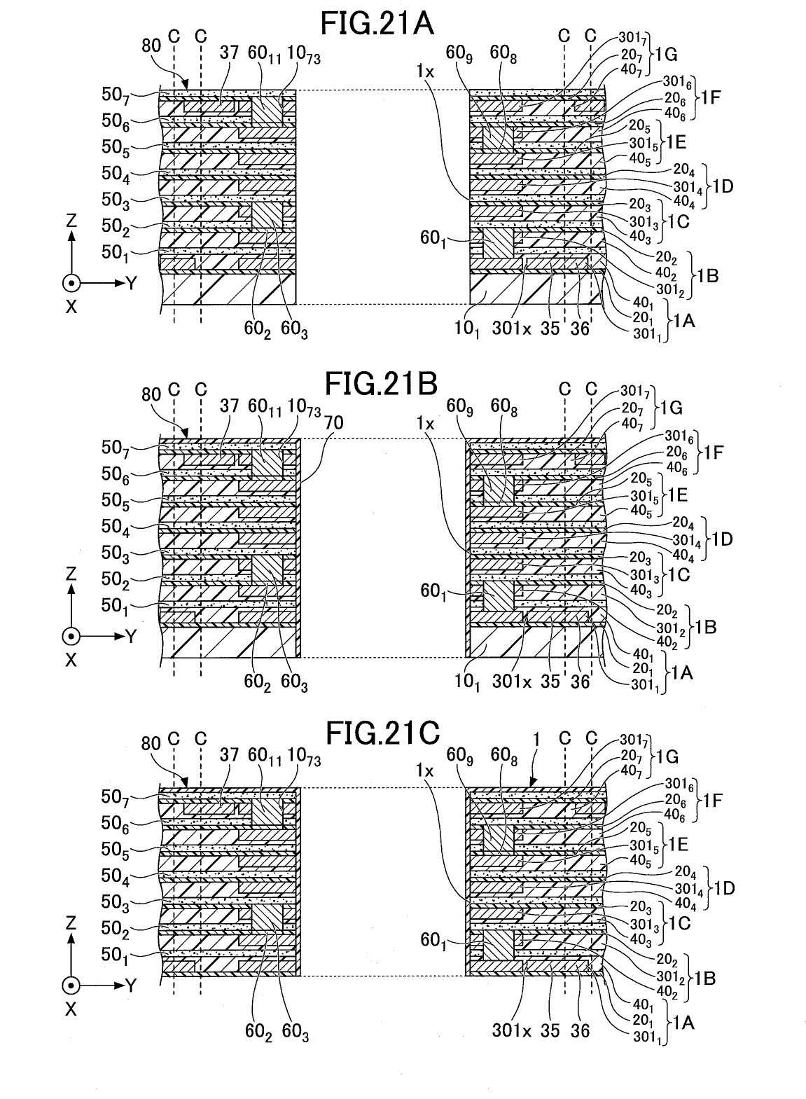

Next, in a step illustrated in FIG. 17A, the adhesion layer 50₇ is stacked on the seventh structure 1G in which an open portion is not provided. Next, in a step illustrated in FIG. 17B, the structure illustrated in FIG. 17A is individualized by being cut along the cut position D illustrated in FIG. 4A and FIG. 43 to form a substrates 1M. For the example illustrated in FIG. 17A and FIG. 173, each of the substrates 1M includes 50 individual areas C. Alternatively, the step illustrated in FIG. 17B may not be performed and the reel (tape) structure for which the steps illustrated in FIG. 21A to FIG. 21C are performed may be shipped as a product.

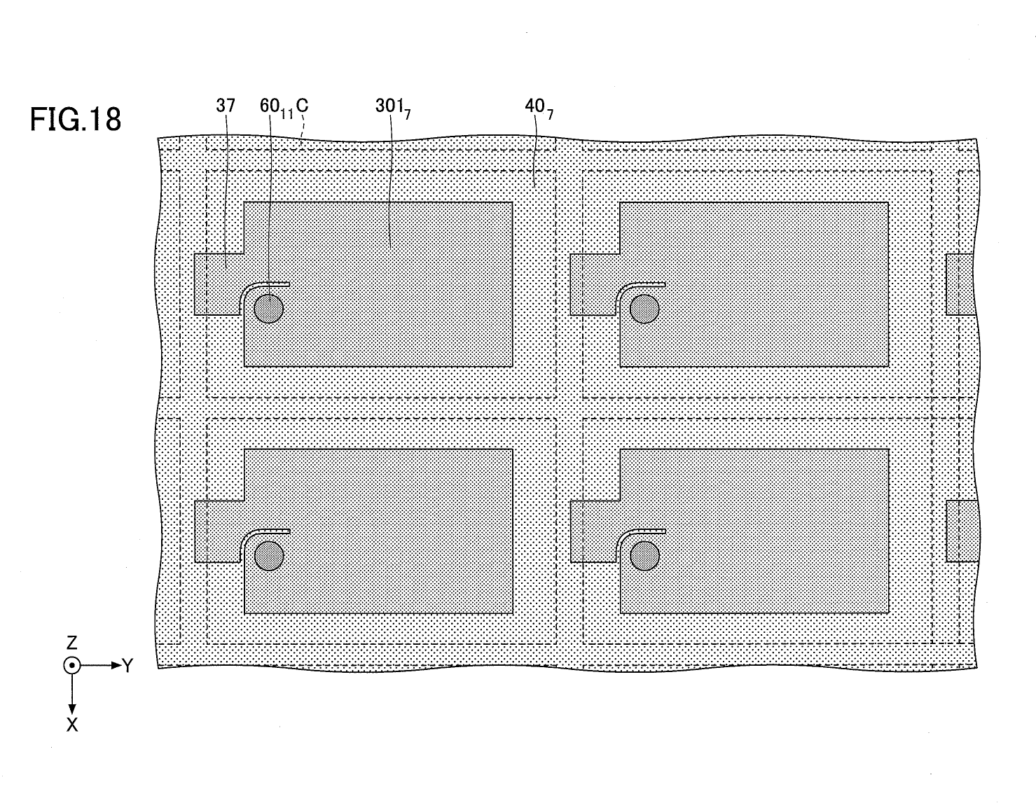

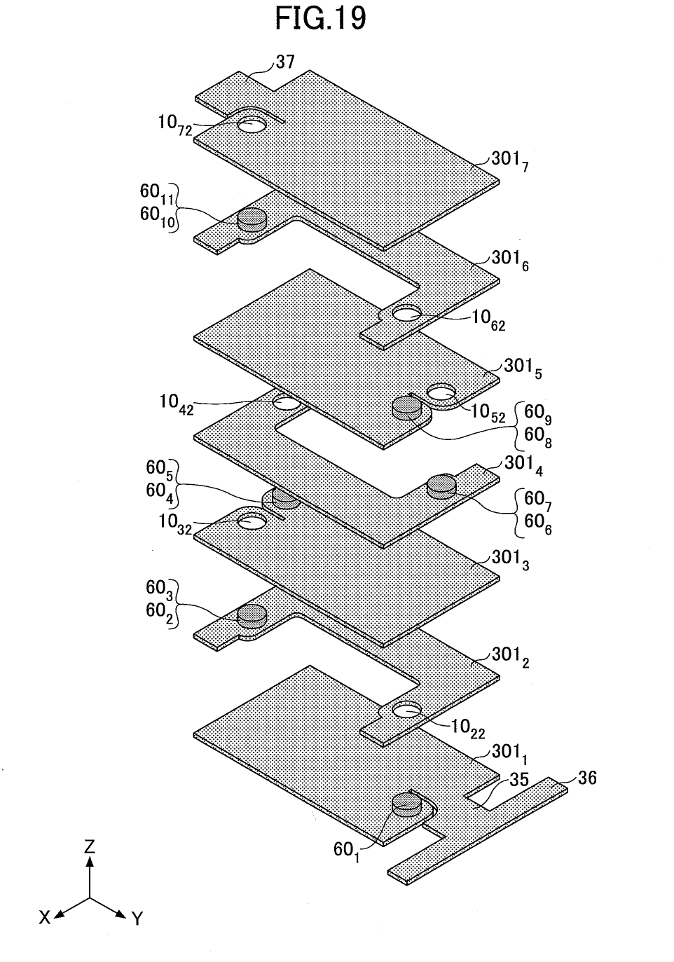

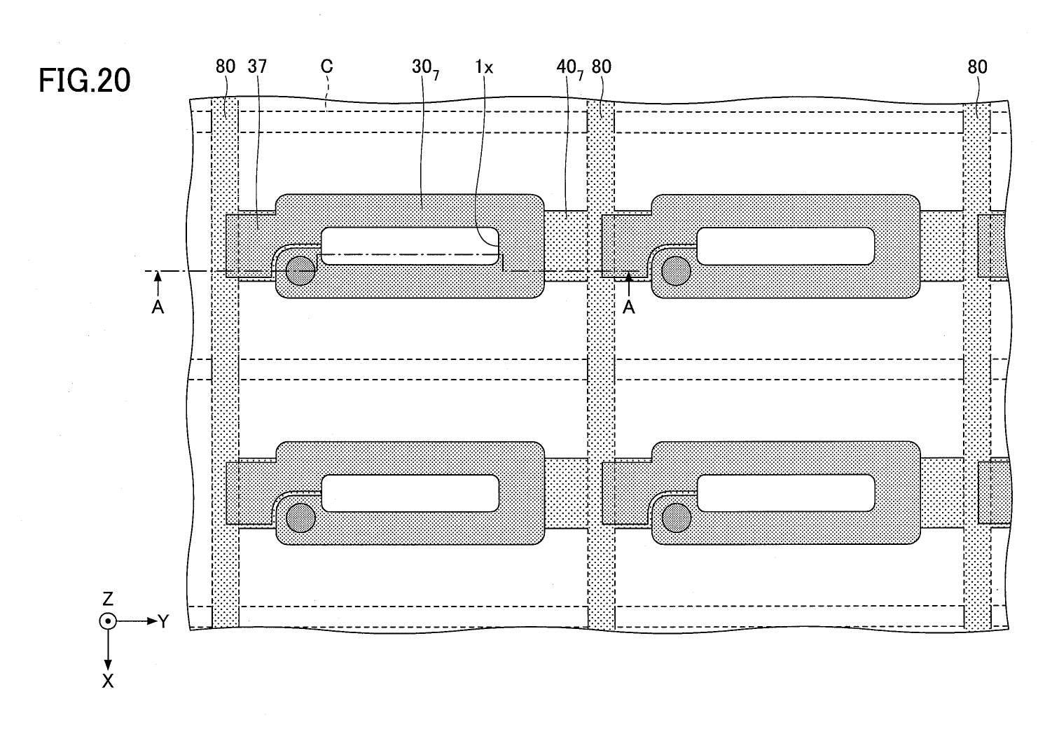

Next, in steps illustrated in FIG. 18 to FIG. 21A, the substrate 1M is shaped (by die cutting or the like) to form the metal layer formed in each of the layers into the wiring that constitutes a part of the spiral-shaped coil by removing unnecessary parts. FIG. 18 is a plan view illustrating an example of the metal layer 301₇ before die cutting or the like the substrate 1M (layers position upper than the metal layer 301₇ are not illustrated). FIG. 19 is a perspective view schematically illustrating each metal layer formed in each of the layers before die cutting or the like the substrate 1M. The substrate 1M in which the metal layers as illustrated in FIG. 18 and FIG. 19 are shaped by press working using a die or the like to be in a form illustrated in FIG. 20 and FIG. 21A. FIG. 20 is a plan view corresponding to FIG. 18 and FIG. 21A is a cross-sectional view of FIG. 20 taken along an A-A line in FIG. 20. The shape of the wiring of each of the layers of the structure illustrated in FIG. 20 and FIG. 21A becomes such as illustrated in FIG. 2. The substrate 1M may be formed by laser processing or the like instead of press working using a die or the like.

With this process, in the stacked structure in which the first structure 1A to the seventh structure 1G are stacked, the metal layer 301₁ is shaped to become the first wiring 30₁. Similarly, the metal layers 301₂, 301₃, 301₄, 301₅, 301₆ and 301₇ are shaped to become the second wiring 30₂, the third wiring 30₃, the fourth wiring 30₄, the fifth wiring 30₅, sixth wiring 30₆ and the seventh wiring 30₇, respectively. The first wiring 30₁, the second wiring 30₂, the third wiring 30₃, the fourth wiring 30₄, the fifth wiring 30₅, the sixth wiring 30₆ and the seventh wiring 30₇ are electrically connected in series through the via wirings to constitute the spiral-shaped coil of about 5 and ½ rolls.

The stacked structured in each of which the first structure 1A to the seventh structure 1G are stacked are formed in the individual areas C, respectively, and are connected (not electrically connected) through linking portions 80 including the insulating layer 40₇ or the like formed between the adjacent individual areas C. The insulating layer 40₇ or the like that constitutes the stacked structure of each of the individual areas C also has the substantially the same shape as the wiring and the through hole 1x that penetrates the layers is formed at a substantially center portion of each of the stacked structures.

Next, in steps illustrated in FIG. 215, the insulating film 70 is formed so as to cover the surfaces of the stacked structure in which the first structure 1A to the seventh structure 1G are stacked except the bottom surface. This means that the insulating film 70 is formed that continuously covers the outer wall surface (sidewall) of the stacked structure formed at each of the individual areas C, the upper surface of the adhesion layer 50₇ and the inner wall surface of the through hole 1x (see FIG. 1C far plan shape). As the end surfaces of the wirings are exposed at the outer wall surface (sidewall) of the stacked structure or at the inner wall surface of the through hole 1x, there is a possibility that short between the wirings and the conductive material (magnetic filler or the like) that may be included in the sealing resin 110 may occur when the inductor 100 (see FIG. 3) is manufactured. Thus, by forming the insulating film 70 at surfaces of the stacked structure, the short between the wirings and the conductive material (magnetic filler or the like) that may be included in the sealing resin 110 is prevented.

For the insulating film 70, epoxy based insulating resin, acrylic based insulating resin or the like may be used, for example. The insulating film 70 may include filler such as silica or the like, for example. The insulating film 70 may be formed by spin coating, spray coating or the like, for example. Electrodepositing resist may be used as the insulating film 70. In this case, the electrodepositing resist is deposited only on the end surfaces of the wirings that are exposed at the outer wall surface (sidewall) of the stacked structure or the inner wall surface of the through hole 1x by electrodeposition coating. The thickness of the insulating film 70 may be about 20 to 50 μm, for example.

Next, in a step illustrated in FIG. 21C, the substrate 10₁ is removed from the insulating layer 20₁. With this, the coil substrate 1 (see FIG. 1A to FIG. 1C) is formed in each of the individual areas C. The coil substrates 1 at the adjacent individual areas C are connected (not electrically connected) with each other through the linking portion 80 that is formed between those adjacent individual areas C.

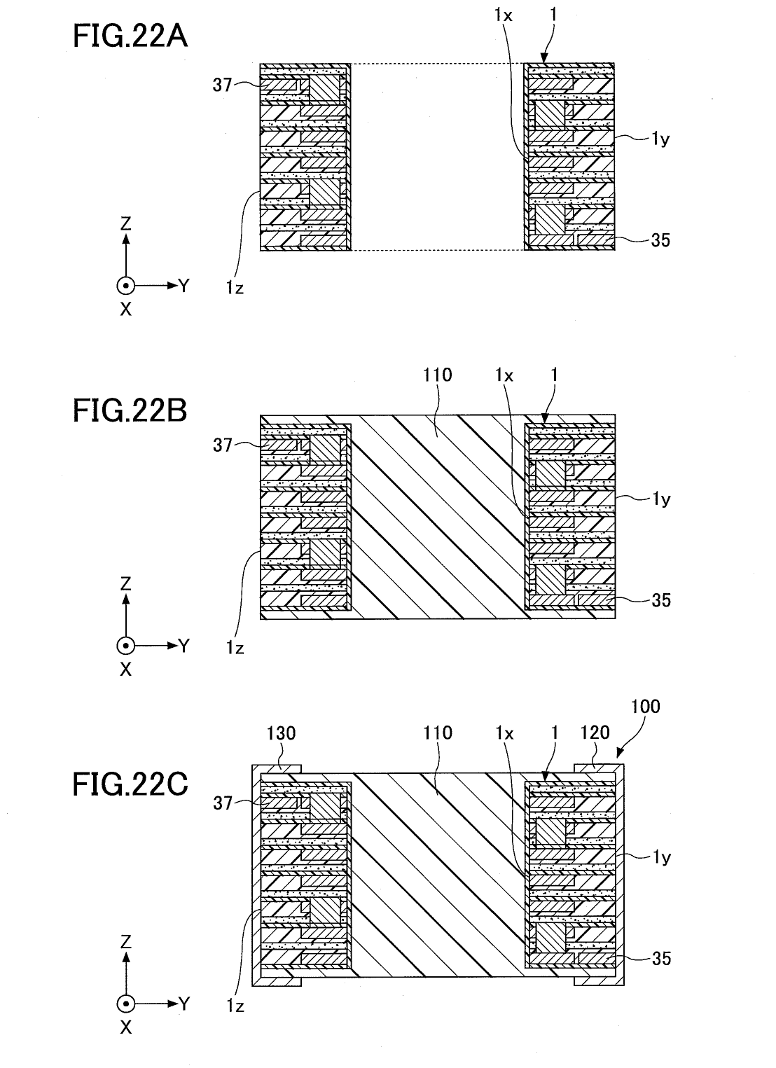

In order to manufacture the inductor 100 (see FIG. 3), as illustrated in FIG. 22A, the coil substrates 1 illustrated in FIG. 21C are cut for each of the individual areas C, for example. With this, the linking portions 80 are removed and the individualized plurality of coil substrates 1 are formed. At this time, the side surface of the connecting portion 35 is exposed at the one side surface 1y and the side surface of the connecting portion 37 is exposed at the other side surface 1z, of each of the coil substrates 1.

Next, as illustrated in FIG. 22B, the sealing resin 110 is formed to seal the coil substrate 1 except the one side surface 1y and the side surface 1z by transfer mold or the like, for example. For the sealing resin 110, insulating resin such as epoxy based insulating resin or the like including magnetic filler such as ferrite or the like may be used, for example. Alternatively, the sealing resin 110 may be formed for the entirety of the individual areas C where the coil substrates 1 which are connected with each other through the linking portions 80 are formed as illustrated in FIG. 21C, and then, the coil substrates 1 may be cut to with the sealing resin 110 for each of the individual areas C to form the structure illustrated in FIG. 22B.

Next, as illustrated in FIG. 22C, the electrode 120 composed of copper (Cu) or the like that continuously covers the one side surface and parts of the upper surface and the lower surface of the sealing resin 110 is formed by plating or paste coating. The inner wall surface of the electrode 120 contacts the side surface of the connecting portion 35 that is exposed from the one side surface 1y of the coil substrate 1 so that the electrode 120 and the connecting portion 35 are electrically connected. Similarly, the electrode 130 composed of copper (Cu) or the like that continuously covers the other side surface and parts of the upper surface and the lower surface of the sealing resin 110 is formed by plating or paste coating. The inner wall surface of the electrode 130 contacts the side surface of the connecting portion 37 that is exposed from the other side surface 1z of the coil substrate 1 so that the electrode 130 and the connecting portion 37 are electrically connected. With this, the inductor 100 is completed.

As such, according to the coil substrate 1 of the embodiment, a single spiral-shaped coil is formed by manufacturing a plurality of structures in each of which a wiring that becomes a part of the spiral-shaped coil is covered by an insulating film, and stacking the structures through adhesion layers, respectively, such that the wirings of the structures are connected in series through via wirings, respectively. With this, by increasing the stacking number of the structures, a coil with the desired number of rolls can be obtained without changing the plan shape. This means that the number of rolls (the number of turns) of the coil can be increased with a size smaller (the plan shape of about 1.6 mm×0.8 mm, for example) than conventional coils.

Further, for example, a method may be considered in which a wiring that constitutes a part of a coil is previously patterned in each structure, and then the structures are stacked. However, in such a method, there may be shifts between the wirings of the structures in a leftward/rightward direction so that the wirings may not be stacked to completely overlap with each other in a plan view. Then, when a through hole or the like is formed in the stacked structure, a part of the wirings, which may be shifted with each other, may be removed. This kind of problem may be resolved by making the width of each of the wirings, which is previously formed in the respective structure, smaller in order to ensure areas where the wirings are not formed. However, in such a case, direct current resistance of the coil may be increased.

On the other hand, according to the method of manufacturing the coil substrate of the embodiment, a metal layer having a plan shape larger than that of a wiring of a final product is formed in each structure, a stacked structure is formed by stacking the structures, and the stacked structure is shaped in the thickness direction such as to form the metal layers into the shape of wirings each having a shape to constitute the spiral-shaped coil at the same time. Thus, the wirings are not shifted in the leftward/rightward direction, and the spiral-shaped coil can be obtained by the wirings that are stacked to high accurately overlap with each other in a plan view. As a result, direct current resistance can be decreased. This means that each of the wirings can be made wider so that the direct current resistance can be decreased as there is no need to worry about the shifts of the wirings in the leftward/rightward direction.

Further, as the number of rolls of the coil can be increased by increasing the stacking number of the structures without changing the plan shape, a small-size coil substrate with larger inductance can be easily obtained.

Further, a width of a wiring that is formed in each structure (one layer) can be made wider because the number of rolls of the wiring that is formed in each of the structures (one layer) is less than or equal to one of the coil. Thus, it is possible to increase the cross section of the wiring in the width direction, and winding resistance that influences performance of the inductor can be decreased.

Further, although the flexible insulating resin film (polyphenylenesulfide film or the like, for example) is used as the substrate 10n when manufacturing the coil substrate 1, the substrate 10n is removed and does not remain in a final product. Thus, the coil substrate 1 can be made thinner.

Further, by using a reel (tape) flexible insulating resin film (polyphenylenesulfide film or the like, for example) as the substrate 10n, the coil substrate 1 can be formed on the substrate 10n in a reel to reel process. With this, the cost for manufacturing the coil substrate 1 can be reduced due to mass production.

According to the embodiment, a smaller coil substrate or the like can be provided.

Although a preferred embodiment of the coil substrate, the method of manufacturing the coil substrate and the inductor has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

For example, a combination of the number of rolls that each wiring (one layer) of each of a plurality of structures has, may be arbitrarily determined. For example, a combination of the wirings of about one roll and the wirings of about ¾ roll may be used as the above explained embodiment, or alternatively, a combination of wirings of about one roll and wirings of about ½ roll may be used. When the wirings of about ¾ roll are used, 4 kinds of pattern of wirings (the second wiring 30₂, the third wiring 30₃, the fourth wiring 30₄ and the fifth wiring 30₅, for example) are necessary. However, when the wirings of about ½ roll are used, only two kinds of pattern of wirings are necessary.

Further, in the above embodiment, “electrically connected in series” means that each of the wirings is connected to a first wiring that is included in an adjacent lower structure, for example, at one end, and is connected to a second wiring that is included in an adjacent upper structure, for example, at another end. Specifically, with reference to FIG. 2, one end (where the open portion 10₂₂ is formed) of the second wiring 30₂ is connected to the first wiring 30₁ while another end (where the via wirings 60₂ and 60₃ are formed) of the second wiring 30₂ is connected to the third wiring 30₃.

What is claimed is:

1. A coil substrate comprising:
a stacked structure in which a plurality of structures are stacked, each of the structures including a first insulating layer and a wiring formed on the first insulating layer, which becomes a part of a spiral-shaped coil; and
an insulating film that covers a surface of the stacked structure, the spiral-shaped coil being formed by connecting the wirings of the adjacent structures in series.

2. The coil substrate according to claim 1, wherein each of the structures further includes a second insulating layer formed on the first insulating layer such as to cover the wiring.

3. The coil substrate according to claim 1,
wherein a part of an end surface of the wiring of each of the structures is exposed at an outer wall surface of the stacked structure, and
wherein the end surface of the wiring of each of the structures exposed at the outer wall surface is covered by the insulating film.

4. The coil substrate according to claim 1,
wherein the stacked structure is provided with a through hole that penetrates the stacked structure such that a part of an end surface of the wiring of each of the structures is exposed at an inner wall surface of the through hole, and
wherein the end surface of the wiring of each of the structures exposed at the inner wall surface is covered by the insulating film.

5. The coil substrate according to claim 1, wherein the wiring of each of the structures is less than or equal to one roll of the spiral-shaped coil.

6. The coil substrate according to claim 1,
wherein in at least one of the structures, a connecting portion is provided at an end portion of the respective wiring that is integrally formed with the wiring, and
wherein a part of the connecting portion is exposed from the insulating film.

7. The coil substrate according to claim 1, further comprising a plurality of a combination of the stacked structure and the insulating film, the combinations being aligned while being connected with each other through a linking portion.

8. The coil substrate according to claim 1, wherein the first insulating layer is made of insulating resin.

9. The coil substrate according to claim 1, wherein the insulating film is made of insulating resin.

10. The coil substrate according to claim 2, wherein the second insulating layer is made of insulating resin.

11. An inductor comprising:
the coil substrate according to claim 6;
a resin including a magnetic material that covers the coil substrate while exposing the part of the connecting portion; and
an electrode formed on the resin and electrically connected to the part of the connecting portion.

12. The inductor according to claim 11, wherein the resin is filled in a through hole that penetrates the coil substrate.

13. The inductor according to claim 11, wherein the magnetic material is magnetic filler.

14. An inductor comprising:
the coil substrate according to claim 6 provided with a through hole that penetrates the coil substrate; and
a magnetic material filled in the through hole.
